(19) United States
(12) Patent Application Publication
(10) Pub. No.: US 2026/0134376 A1
(43) Pub. Date: May 14, 2026

(54) Systems and Methods for Governance-Driven Corporate Management

(71) Applicant: CorpRite Technologies Inc., Toronto (CA)

(72) Inventor: Tyler Benoliel, Toronto (CA)

(21) Appl. No.: 19/444,056

(22) Filed: Jan. 8, 2026

Related U.S. Application Data
(63) Continuation-in-part of application No. 18/470,511, filed on Sep. 20, 2023, now abandoned.
(60) Provisional application No. 63/855,487, filed on Aug. 1, 2025.

(51) Int. Cl. G06Q 10/0637

(52) U.S. Cl. CPC G06Q 10/0637

(57) ABSTRACT

A system comprising one or more processors; a non-transitory, machine-readable memory storing instructions that, when executed by the one or more processors, cause the processors to: ingest and analyze corporate governance data from one or more sources including uploaded documents, internal records, and external data sources; derive, from the analyzed corporate governance data, governance constraints, compliance conditions, and authorization requirements; control execution of one or more corporate actions based on satisfaction of the governance constraints, compliance conditions, and authorization requirements; record execution of the one or more corporate actions in a tamper-resistant or append-only audit record; and maintain a structured, entity-specific corporate state reflecting the executed corporate actions; wherein execution of the instructions is configurable per entity, jurisdiction, or user-defined governance policy.

### FIELD OF THE DISCLOSURE

This disclosure relates to business corporate management in general, and more particularly, to a software application for corporate management that implements blockchain and artificial intelligence (AI) technologies to enhance reliability, security, and efficiency.

### BACKGROUND

The incorporation and ongoing management of corporate entities have traditionally been characterized by bureaucratic complexity, high operational overhead, and susceptibility to human error. These processes typically involve multiple intermediaries such as lawyers, accountants, and government agencies, each contributing to delays, costs, and a fragmented record-keeping system. Incorporation documents, shareholder agreements, governance protocols, and compliance records are often stored in siloed systems, leading to a lack of interoperability and an increased risk of inconsistencies or omissions.

Moreover, existing digital systems for corporate governance, while improving access and convenience, often fall short in terms of data integrity, auditability, and security. Many of these systems are centralized, meaning that they are vulnerable to unauthorized access, data tampering, and single points of failure. Additionally, such systems usually provide limited automation, requiring continued human oversight for regulatory compliance, document versioning, voting processes, and corporate actions.

Another significant drawback of current solutions is the lack of transparency for stakeholders. Shareholders, board members, and regulatory bodies may face delays in accessing up-to-date and verifiable information, resulting in poor governance and weakened trust. Furthermore, the manual nature of many corporate processes introduces inefficiencies that can hinder business agility and compliance with evolving regulatory frameworks.

As such, there is a need for a system that leverages both blockchain and AI technologies to achieve secure, efficient, and transparent incorporation and corporate management. By utilizing blockchain or other tamper-resistant ledger technologies, the system may ensure tamper-proof record-keeping, decentralized trust, and real-time auditability. Meanwhile, AI may enhance capabilities of the system by automating routine compliance tasks, detecting anomalies, interpreting regulatory requirements, and providing decision-making support. Together, these technologies have the potential to offer a next-generation solution to streamline corporate operations, improve transparency, reduce human error, and strengthen governance practices.

### SUMMARY

The following presents a simplified summary of some embodiments of the techniques described herein in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Some embodiments provide a tangible, non-transitory, machine-readable medium storing instructions that when executed by one or more processors cause the one or more processors to: ingest and analyze corporate governance data from one or more sources including uploaded documents, internal records, and external data sources; derive, from the analyzed corporate governance data, one or more of governance constraints, compliance conditions, and authorization requirements; control execution of one or more corporate actions based on satisfaction of the one or more of the governance constraints, the compliance conditions, and the authorization requirements; record execution of the one or more corporate actions in a tamper-resistant or append-only audit record; and maintain a structured, entity-specific corporate state reflecting the executed one or more corporate actions; wherein execution of the instructions is configurable per one or more of entity, jurisdiction, and user-defined governance policy.

Some embodiments provide a tangible, non-transitory, machine-readable medium storing instructions that when executed by one or more processors cause the one or more processors to: analyze, using a machine learning engine trained on corporate legal data sets, corporate governance data; identify, using the machine learning engine, legal or compliance requirements; automatically execute, using a smart contract engine, predefined corporate actions upon satisfaction of governance rules or data-driven triggers; record in a tamper-resistant or append-only manner each executed action to a blockchain ledger; and parse uploaded or external registry data, using the machine learning engine, to extract structured corporate information; wherein the instructions are modularly configurable per entity, jurisdiction, or user-defined governance policy.

In some embodiments, the instructions executed by the one or more processors further cause the one or more processors to generate, using the machine learning engine, one or more legal documents or governance instruments including: incorporation papers, shareholder agreements, resolutions, option plans, and consents.

In some embodiments, the instructions executed by the one or more processors further cause the one or more processors to: store, using a minute book module, corporate documents including organizational documents, legal agreements, and board resolutions; and link one or more of the stored documents to corresponding tamper-resistant or append-only audit events.

In some embodiments, the instructions executed by the one or more processors further cause the one or more processors to: identify, using the machine learning engine, one or more compliance gaps in corporate governance data; invoke, using the smart contract engine, a remedial action upon identification of the one or more compliance gaps; and execute, using the smart contract engine, the remedial action.

In some embodiments, the instructions executed by the one or more processors further cause the one or more processors to: detect, using the machine learning engine, discrepancies between internal records and public registry data; and generate, file, or request registry updates to correct the discrepancies.

In some embodiments, the instructions executed by the one or more processors further cause the one or more processors to assess, using the machine learning engine, legal and compliance posture, the assessment including: assessing governance document completeness, registry mismatches, and filing history; assigning a risk score based on the governance document completeness, the registry mismatches, and the filing history; and suggesting corrective actions based on the assigned risk score or other findings from the assessment.

In some embodiments, the predefined corporate actions include one or more of: issuing equity as tokenized shares; converting convertible instruments; processing share transfers, redemptions, or conversions; updating a cap table; issuing dividends; scheduling and executing shareholder votes or proxy solicitations; distributing meeting notices or other stakeholder notifications; enforcing vesting schedules; performing share buybacks or treasury-share management; handling equity splits or consolidations; managing tokenized debt instruments; triggering corporate events; automating annual-report or other jurisdictional compliance filings; minting or burning tokenized securities; and generating and submitting regulatory filings or notices.

In some embodiments, the governance rules include one or more of: board approved share caps; jurisdiction specific filing deadlines; super majority vote thresholds; and officer signature requirements.

In some embodiments, the data driven triggers include one or more of: a cap table dilution greater than or equal to a first threshold percentage; a financing round being closed; an option pool utilization greater than or equal to a second threshold percentage; and a compliance deadline occurring within a third threshold number of days.

In some embodiments, the instructions executed by the one or more processors further cause the one or more processors to simulate, using the machine learning engine, changes to a cap table based on one or more hypothetical events defined by a user or derived from extracted corporate data, the simulation including one or more of: funding rounds; pro rata rights; option pool adjustments; and convertible note conversions.

In some embodiments, the instructions executed by the one or more processors further cause the one or more processors to represent equity or convertible instruments as blockchain-based tokens governed by smart contract logic.

In some embodiments, the instructions executed by the one or more processors further cause the one or more processors to manage access control and permissions via smart contract logic and blockchain-based identities.

In some embodiments, the instructions executed by the one or more processors further cause the one or more processors to onboard multiple corporate entities, onboarding including: uploading a digital minute book or governance documents; extracting data from the digital minute book or governance documents using the machine learning engine; retrieving supplemental corporate data from public registries; and organizing the extracted data and the supplemental corporate data into structured corporate profiles.

In some embodiments, the instructions executed by the one or more processors further cause the one or more processors to configure smart contract logic to vary execution based on user roles or digital signatures.

In some embodiments, the instructions executed by the one or more processors further cause the one or more processors to: dynamically generate, select, or modify one or more of governance and transactional document templates using a machine learning engine based on extracted corporate governance data, historical corporate actions, entity type, jurisdiction-specific requirements, and user role; determine required approval thresholds and authorized signatories for execution of the one or more of the governance or the transactional documents; and control execution of the corresponding one or more corporate actions such that execution is permitted only after receipt of required electronic signatures or approvals, wherein the executed one or more of the governance or the transactional documents and associated signature events are linked in a tamper-resistant or append-only manner to the corporate action record.

In some embodiments, the instructions executed by the one or more processors further cause the one or more processors to: retain, using a version control mechanism, historical records of corporate actions; and record in a tamper-resistant or append-only manner, using the version control mechanism, new versions of corporate actions.

In some embodiments, the instructions include a modular architecture that customizes workflows by entity, jurisdiction, or a user-defined governance policy.

In some embodiments, the instructions executed by the one or more processors further cause the one or more processors to: compute, using the machine learning engine, a confidence score for each prospective corporate action; and in response to the confidence score of a prospective corporate action falling below a predefined confidence threshold, route the prospective corporate action to a human for approval or manual execution, or in response to the confidence score of the prospective corporate action being above the predefined confidence threshold, automatically execute, using the smart contract engine, the prospective corporate action and record in a tamper-resistant or append-only manner the executed action to the blockchain ledger.

Some embodiments provide a system, including: one or more processors; and a non-transitory, machine-readable memory storing instructions that, when executed by the one or more processors, cause the one or more processors to: ingest and analyze corporate governance data from one or more sources including uploaded documents, internal records, and external data sources; derive one or more of governance constraints, compliance conditions, and authorization requirements from the analyzed corporate governance data; control execution of one or more corporate actions based on satisfaction of the one or more of the governance constraints, the compliance conditions, and the authorization requirements; record execution of the one or more corporate actions in a tamper-resistant or append-only audit record; and maintain a structured, entity-specific corporate state reflecting the executed one or more corporate actions; wherein the system is configurable per one or more of entity, jurisdiction, and user-defined governance policy.

Some embodiments provide a system, including: one or more processors; a non-transitory, machine-readable memory storing instructions that, when executed by the one or more processors, cause the processors to: analyze, using a machine learning engine trained on corporate legal data sets, corporate governance data; identify, using the machine learning engine, legal or compliance requirements; automatically execute, using a smart contract engine, predefined corporate actions upon satisfaction of governance rules or data-driven triggers; record in a tamper-resistant or append-only manner each executed action to a blockchain ledger; and parse uploaded or external registry data, using the machine learning engine, to extract structured corporate information; wherein the system is modularly configurable to support multiple entities, jurisdictions, or user defined governance policies.

One or more of the above recited embodiments are implemented by and/or within the above-described systems.

Some embodiments include a method, including: ingesting and analyzing, by one or more processors, corporate governance data from one or more sources including uploaded documents, internal records, and external data sources; deriving, by the one or more processors, one or more of governance constraints, compliance conditions, and authorization requirements from the analyzed corporate governance data; controlling execution, by the one or more processors, of one or more of corporate actions based on satisfaction of the governance constraints, compliance conditions, and authorization requirements; recording execution of the one or more corporate actions in a tamper-resistant or append-only audit record; and maintaining a structured, entity-specific corporate state reflecting the executed one or more corporate actions; wherein the method is configurable per one or more of entity, jurisdiction, and user-defined governance policy.

Some embodiments include a method, including: analyzing, by one or more processors, using a trained machine learning engine, corporate governance data; identifying, by the one or more processors, using the machine learning engine, legal or compliance requirements; automatically executing, by the one or more processors, using a smart contract engine, predefined corporate actions upon satisfaction of governance rules or data-driven triggers; recording in a tamper-resistant or append-only manner, by the one or more processors, each executed action to a blockchain ledger; and parsing uploaded or external registry data, by the one or more processors, using the trained machine learning engine, to extract structured corporate information; wherein the method is performed under a modular configuration selectable per entity, jurisdiction, or user-defined governance policy.

One or more of the above recited embodiments are implemented by and/or within the above-described methods.

### BRIEF DESCRIPTION OF THE FIGURES

FIG. 1 illustrates an example of a user interface of a login module of a software application, according to some embodiments.

FIG. 2 illustrates an example of a user interface of a homepage module of the software application, according to some embodiments.

FIGS. 3A-3R illustrate an example of user interfaces of an organization creation module of the software application, according to some embodiments.

FIG. 4A illustrates an example of a user interface of a profile module of the software application, according to some embodiments.

FIGS. 4B-4J an example of user interfaces of a dashboard module of the software application, according to some embodiments.

FIGS. 5A-5C illustrate an example of user interfaces of a minute book module of the software application, according to some embodiments.

FIGS. 6A-6G illustrate an example of user interfaces of an actions module of the software application, according to some embodiments.

FIGS. 7A and 7B illustrate an example of user interfaces of an activity module of the software application, according to some embodiments.

FIG. 8 illustrates an example of a user interface of a members submodule of the software application, according to some embodiments.

FIG. 9 illustrates an example of a user interface of a dashboard module of a software application, according to some embodiments.

FIG. 10 illustrates a diagram of a Hyperledger Fabric blockchain network integrated with the software application, according to some embodiments.

FIG. 11 illustrates an example of a user interface of the software application configured to autonomously execute corporate actions, according to some embodiments.

FIG. 12 illustrates an example of a user interface of the software application configured issue equity or convertible instruments as blockchain-backed tokens, according to some embodiments.

FIG. 13 illustrates an example of a user interface the software application configured to autonomously generate documents, according to some embodiments.

FIG. 14 illustrates an example a user interface of the software application configured to automatically populate corporate records, according to some embodiments.

FIG. 15 illustrates an example of a user interface of the software application configured to simulate a cap table and chart, according to some embodiments.

FIG. 16 illustrates an example of a user interface of a software application configured to autonomously and actively identify gaps or inconsistencies, according to some embodiments.

FIG. 17 illustrates an example of a user interface of the software application configured to generate a risk score, according to some embodiments.

FIG. 18 illustrates an example of a user interface of the software application configured to extract registry data of an organization and generate discrepancies with information stored within the software application, according to some embodiments.

FIG. 19 illustrates an example of a workflow of the software application, according to some embodiments.

### DETAILED DESCRIPTION OF SOME EMBODIMENTS

The present inventions will now be described in detail with reference to a few embodiments thereof as illustrated in the accompanying drawings. In the following description, numerous specific details are set forth in order to provide a thorough understanding of the present inventions. It will be apparent, however, to one skilled in the art, that the present invention may be practiced without some or all of these specific details. In other instances, well known process steps and/or structures have not been described in detail in order to not unnecessarily obscure the present invention. Further, it should be emphasized that several inventive techniques are described, and embodiments are not limited to systems implanting all of those techniques, as various cost and engineering trade-offs may warrant systems that only afford a subset of the benefits described herein or that will be apparent to one of ordinary skill in the art.

The present invention discloses a novel and innovative system and method of use thereof that leverages the benefits of blockchain and AI technologies for transparent, secure, streamlined, and efficient corporate management. The system is implemented as a software application including a plurality of modules, each configured to perform a distinct function related to corporate management. The software application may be a web-based or downloadable application executed on a communication device (e.g., mobile phone, tablet, laptop, desktop computer, etc.).

In some embodiments, the software application may be configured to receive at least one input via a user interface of a login module of the software application designating an email and a password of a user and an instruction to login, upon which the login module may be configured to login to a profile of the user. In some embodiments, upon logging in, a homepage module of the software application may be configured to display, via a user interface of the homepage module, at least one of a current plan tier (e.g., enterprise, foundation, growth, mid-scale, scale, etc.), a number of organizations created, and a list of each organization created and their associated jurisdiction (e.g., Ontario, California, Canada, Federal, Texas, etc.) and incorporation status (e.g., pending, incorporated) and a last date any updates were made to the organization. In some embodiments, the homepage module may be configured to receive at least one input via the user interface of the homepage module designating at least one of an instruction to create an organization and an instruction to view an organization within the list of organizations displayed by the homepage module.

Upon receiving the instruction to create an organization, the software application may be configured to initiate an AI-driven organization onboarding process via an organization creation module. In some embodiments, the organization creation module is configured to receive one or more governance documents, such as a digital minute book, incorporation documents, shareholder registers, resolutions, or other corporate records, and/or to retrieve corporate data from one or more public registries associated with a selected jurisdiction. Using a customized machine learning engine, the organization creation module may be configured to parse, analyze, and extract structured corporate information from the received documents and registry data, including corporation information comprising at least one of a corporation name, jurisdiction, date of incorporation, fiscal year end, industry, business number, and address. The extracted information may be used to automatically populate a proposed corporate profile for user review. In some embodiments, the organization creation module may be configured to receive at least one input via a user interface of the organization creation module designating one or more corporation information or deletion thereof.

In some embodiments, as part of the onboarding process, the organization creation module may be configured to identify and extract share class information from the received documents and registry data. The extracted share class information may include at least one of share class type, share class name, priority rights, voting rights, votes per share, number of authorized shares, and creation date. The organization creation module may be configured to display the extracted share class information via a user interface for review, confirmation, modification, or supplementation by a user. In some embodiments, the organization creation module assigns a confidence score to the extracted share class information and flags one or more fields for review based on the confidence score. In some embodiments, the organization creation module may be configured to receive at least one input via a user interface of the organization creation module designating one or more share class information or deletion thereof.

In some embodiments, the organization creation module may be configured to extract shareholder information from the received documents, including individual shareholder information and company shareholder information. The extracted shareholder information may include at least one of name, contact information, citizenship, associated share class, amount of shares or percentage ownership, and issuance date. The organization creation module may be configured to display the extracted shareholder information via the user interface, including a visualization of ownership distribution. A user may review, modify, confirm, or supplement the extracted shareholder information, including adjusting the representation of ownership as a number of shares or as a percentage. In some embodiments, the organization creation module may be configured to receive at least one input via a user interface of the organization creation module designating one or more shareholder information or deletion thereof.

In some embodiments, the organization creation module may be configured to extract and populate director information, officer information, equity instrument information, and option plan information from the received documents and registry data. Director and officer information may include at least one of name, role, appointment or election date, and contact information. Equity instrument and option plan information may include one or more of instrument type, investor name, investment amount, valuation cap, discount rate, vesting terms, conversion triggers, maturity dates, and creation dates. The organization creation module may be configured to display the extracted information via the user interface for user confirmation, editing, deletion, or conversion of instruments to equity, as applicable. In some embodiments, the organization creation module may be configured to receive at least one input via a user interface of the organization creation module designating at least one of one or more director information or deletion thereof, one or more officer information or deletion thereof, one or more equity instrument information or deletion thereof, and one or more option plan information or deletion thereof.

Upon user confirmation of the extracted and populated onboarding information, the organization creation module may be configured to finalize the structured corporate profile and automatically organize the received documents into appropriate sections of a minute book module. In some embodiments, the organization creation module generates one or more activity log entries reflecting onboarding actions and launches a profile module of the software application for the organization. The profile module for a particular organization may also be launched from the homepage module upon receipt of an instruction to view the organization.

The profile module for each organization includes one or more of a dashboard module, a minute book module, an actions module, an activity module, and a settings module. The profile module may be configured to receive at least one input designating an instruction to launch any of the dashboard module, the minute book module, the actions module, the activity module, and the settings module, upon which the respective module may be launched. The profile module may be configured to receive at least one input designating an instruction to view a profile of the user, an instruction to change the password of the user, and an instruction to logout. Upon receiving the instruction to view the profile, the profile module may be configured to display, via the user interface, profile information (e.g., name, email, address, and phone number) and receive at least one input designating one or more profile information and an instruction to save the profile information. Upon receiving the instruction to change the password, the profile module may be configured to receive at least one input designating a current password, a new password, and an instruction to update the password. The profile module may be configured to display, via the user interface, notifications (e.g., compliance alerts, cap table changes, document uploads, smart contract executions, governance event reminders, user activity updates, etc.). The profile module may be configured to receive at least one input designating an item to search and an instruction to search for the item and to display the search results.

The dashboard module provides an overview of essential company information. The dashboard module may be configured to receive at least one input via the user interface of the dashboard module designating an instruction to launch a general information submodule, upon which the dashboard module may be configured to display, via a user interface of the dashboard module, at least one of company information (e.g., date of incorporation, address, business identification/number, corporation/entity identification, jurisdiction, file number, external identification, company key, industry, client identifiers, and fiscal year end) and a cap table and/or chart illustrating diluted or undiluted shares. The dashboard module may be configured to receive at least one input via the user interface of the dashboard module designating an instruction for the cap table and/or chart to illustrate diluted or undiluted shares, upon which the cap table and/or chart illustrates diluted or undiluted shares as instructed. The dashboard module may be configured to receive at least one input via the user interface of the dashboard module designating an instruction to launch a shareholder submodule, upon which the dashboard module may be configured to display, via the user interface of the dashboard module, at least one of shareholder information (e.g., number of current shareholders and number of current share classes) and the cap table and/or chart. Shareholder information may include, for each shareholder, name, class, ownership (i.e., number of shares), issuance date, and source (e.g., treasury, instrument).

The dashboard module may be configured to receive at least one input via the user interface of the dashboard module designating an instruction to launch a share classes submodule, upon which the dashboard module may be configured to display, via the user interface of the dashboard module, at least one of share classes information (e.g., number of current shareholders and number of current share classes) and the cap table and/or chart. Share classes information may include, for each share class, share class name, voting (e.g., yes or no), and creation date. The dashboard module may be configured to receive at least one input via the user interface of the dashboard module designating an instruction to launch a directors submodule, upon which the software application may be configured to display, via the user interface, current directors including name and elected date, and the cap table and/or chart. The user interface of the dashboard module may be configured to receive input designating an instruction to view board settings, upon which the user interface of the dashboard module is configured to display board settings information including at least one of minimum number of directors, maximum number of directors, and the number of board seats available. The user interface of the dashboard module is further configured to receive input designating an instruction to edit board settings, upon which the user interface of the dashboard module is configured to receive input designating board settings information and an instruction to save the board setting information. The user interface of dashboard module may be configured to receive at least one input via the user interface of the dashboard module designating an instruction to launch an officers submodule, upon which the software application may be configured to display, via the user interface, at least one of officer information (e.g., current officers including name, position, and elected date) and the cap table and/or chart. The dashboard module may be configured to receive at least one input via the user interface of the dashboard module designating an instruction to launch a stock options submodule, upon which the software application may be configured to display, via the user interface, at least one of stock option information and the cap table and/or chart. Stock option information may include, for each stock option, a stock option plan name, total options, a vesting duration, a vesting interval, an issued date, a number of exercised options, and remaining options. The dashboard module may be configured to receive at least one input via the user interface of the dashboard module designating an instruction to launch an instruments submodule, upon which the software application may be configured to display, via the user interface, at least one of instrument information and the cap table and/or chart. Instrument information may include, for each instrument, an instrument name, an instrument type, an investor name, a share class, a conversion status, number of instrument type, number of converted shares, and conversion date.

The dashboard module may be configured to receive at least one input via the user interface of the dashboard module designating an instruction to download an organization summary report, upon which the dashboard module may be configured to download the organization summary report. The organization summary report may include one or more of the company information, the shareholder information, the share classes information, the director information, the officer information, the stock option information, and the instrument information. The dashboard module may be configured to receive at least one input via the user interface of the dashboard module designating which information to include in the organization summary report.

The minute book module of the organization may be configured to automatically organize, store, and manage corporate documents associated with the organization. In some embodiments, the minute book module receives corporate documents via one or more of: (i) ingestion during an AI-driven onboarding process, (ii) automated retrieval from external sources or registries, and (iii) manual upload by a user. Using a customized machine learning engine, the minute book module may be configured to classify and categorize corporate documents based on document type, content, metadata, and extracted corporate information, and to automatically organize the documents into appropriate categories or sections (e.g., minute book folder placement) of a digital minute book or otherwise suggest appropriate categories or sections of the digital minute book for each document, including but not limited to meeting minutes, resolutions, registers, equity records, and governance instruments. In some embodiments, the minute book module requires user confirmation, via a user interface of the minute book module, prior to organizing the documents into appropriate categories or sections. The minute book module may be configured to display, via the user interface of the minute book module, a list of one or more corporate documents stored within the minute book module, including document categories and associated metadata. Upon receiving an instruction to view a corporate document, the minute book module may be configured to display the selected document. Upon receiving an instruction to view a particular category, the minute book module may be configured to display all corporate documents falling within the selected category. In some embodiments, the minute book module may be configured to receive at least one input via the user interface designating an instruction to manually upload, download, edit, rename, relocate, or delete one or more corporate documents, thereby enabling user override or supplementation of the automated organization. In some embodiments, the minute book module may be configured to receive at least one input via the user interface designating a new category, section, or folder for a particular document and a new name for the particular document. The minute book module may further be configured to permit manual creation, modification, or deletion of folders or categories. In some embodiments, the minute book module may be configured to automatically link corporate documents to corresponding corporate events, actions, or activity log entries, based on extracted document content or onboarding data. Additionally or alternatively, the minute book module may receive an instruction via the user interface to manually link a document to a selected event or activity.

The actions module of the organization may be configured to generate, manage, and execute corporate actions based on extracted corporate data, ingested documents, and user instructions. In some embodiments, using a customized machine learning engine, the software application parses one or more documents received during onboarding or stored in a minute book module to identify indicia of corporate actions, including but not limited to changes to directors, officers, shareholders, share classes, equity issuances, option grants, and convertible or derivative instruments. Upon detecting a prospective corporate action, the actions module may be configured to automatically create a proposed action record, pre-populated with parameters extracted from document content or structured corporate data, such as effective dates, parties, quantities, consideration, and applicable governance rules. In some embodiments, the proposed action is assigned a confidence score and is either automatically executed or routed to a user for review, modification, approval, or rejection prior to execution via the actions module user interface. In some embodiments, confidence scores assigned to prospective corporate actions are computed based on extracted data completeness, document consistency, jurisdictional rules, and historical action patterns, and are compared against one or more configurable thresholds to determine whether human review or automatic execution is required.

In some embodiments, the actions module may be further configured to associate one or more supporting documents with a manually initiated corporate action. Upon a user initiating or approving a corporate action through the actions module user interface, the software application may prompt the user to upload, select, or reference one or more supporting documents, including resolutions, agreements, consents, filings, or executed instruments. The supporting documents may be stored within the minute book module, linked to the corresponding action record, and associated in a tamper-resistant or append-only manner with the action by recording a reference to the supporting document within an activity log and, in some embodiments, on a blockchain ledger, thereby creating a verifiable evidentiary record of authorization and execution.

In some embodiments, the generation of governance or transactional documents is performed using a machine learning engine configured to dynamically generate, adapt, or select document templates based on one or more of: extracted corporate data, historical governance actions, jurisdiction-specific requirements, entity type, user role, and prior document versions. The machine learning engine may modify template language, structure, clauses, or required fields to reflect the specific context of the corporate action being executed. In some embodiments, the machine learning engine maintains versioned document templates and selectively inserts, removes, or modifies clauses based on jurisdiction, entity type, historical governance actions, and applicable regulatory requirements. In some embodiments, the software application provides an explanation of template selection or clause modification decisions generated by the machine learning engine.

In some embodiments, the actions module includes an integrated electronic signature subsystem configured to manage execution of generated governance or transactional documents. The electronic signature subsystem may determine required signatories based on the corporate action, governance rules, jurisdictional requirements, or extracted document content, and may route the generated document to one or more users for electronic signature, approval, or acknowledgement. Execution of the corporate action may be contingent upon receipt of the required electronic signatures, after which the executed document is stored in the minute book module and the completed action is recorded in a tamper-resistant or append-only manner within an activity log and, in some embodiments, on a blockchain ledger. In some embodiments, the electronic signature subsystem records, for each signature event, one or more of a signer identity, authentication method, timestamp, cryptographic hash of the signed document, and an execution status, thereby creating a verifiable signature audit trail. In some embodiments, execution of a corporate action is programmatically gated such that execution is prevented until all required electronic signatures or approvals are received. In some embodiments, the electronic signature subsystem complies with jurisdiction-specific electronic signature laws, including ESIGN, UETA, and comparable international frameworks.

The actions module may be configured to receive an input via the user interface of the actions module designating an instruction to view and/or make changes to officers, upon which the software application may be configured to display, via the user interface, at least one of a list of officers and officer information associated with each officer including one or more of an elected date and officer information (e.g., name, email, phone number, address, date of birth, citizenship, officer type, and appointment date). The actions module may be configured to receive at least one input via the user interface of the actions module designating an instruction to view officer information of a particular officer, an instruction to add an officer, an instruction to modify officer information of an officer, and an instruction to delete an officer. Upon receiving the instruction to view officer information of a particular officer, the actions module may be configured to display, via the user interface, the officer information of the particular officer. Upon receiving the instruction to add an officer, the actions module may be configured to receive at least one input designating officer information or a selection of an existing person within the organization stored in the database (e.g., shareholder) to add as an officer and an instruction to save or add the officer. Upon receiving the instruction to modify officer information of an officer, the actions module may be configured to receive at least one input designating officer information and an instruction to save the updated officer information of the officer. Upon receiving the instruction to delete an officer, the actions module may be configured to delete the officer.

The actions module may be configured to receive an input via the user interface of the actions module designating an instruction to view and/or make changes to shareholders, upon which the software application may be configured to display, via the user interface of the actions module, at least one of a list of shareholders, and for each shareholder, shareholder information (e.g., individual or company name, company representative name, email, and position, individual phone number and address, share class, ownership (i.e., number of shares), issuance date, and source (e.g., treasury, instrument). The actions module may be configured to receive an input via the user interface of the actions module designating an instruction to add a shareholder, upon which the actions module may be configured to receive at least one input via the user interface designating one of shareholder information and a selection of an existing person within the organization stored in a database to add as a shareholder. After receiving the shareholder information, the actions module may be configured to receive at least one input via the user interface of the actions module designating at least one of a share class, an amount of shares (e.g., number or percentage), and an issuance date associated with the respective shareholder. The actions module may be configured to receive at least one input via the user interface of the actions module designating an instruction to view shareholder information of a particular shareholder, an instruction to add a shareholder, an instruction to modify shareholder information of a shareholder, and an instruction to delete a shareholder. Upon receiving the instruction to view shareholder information of a particular shareholder, the actions module may be configured to display, via the user interface, the shareholder information of the particular shareholder. Upon receiving the instruction to add a shareholder, the actions module may be configured to receive at least one input designating shareholder information or a selection of an existing person within the organization stored in the database to add as a shareholder, and an instruction to save or add the shareholder. Upon receiving the instruction to modify shareholder information of an officer, the actions module may be configured to receive at least one input designating shareholder information and an instruction to save the updated shareholder information of the shareholder. Upon receiving the instruction to delete a shareholder, the actions module may be configured to delete the shareholder.

The actions module may be configured to receive at least one input via the user interface of the actions module designating an instruction to view and/or make changes to share classes, upon which the actions module may be configured to display, via the user interface of the actions module, at least one of share classes information (e.g., number of current shareholders and number of current share classes). Share classes information may include, for each share class, share class type (e.g., common, preferred, special, custom), share class name, priority rights (none, first priority, over common), voting rights (e.g., yes or no), authorized shares (e.g., unlimited, limited), and creation date. The actions module may be configured to receive at least one input via the user interface of the actions module designating one or more of an instruction to add a share class, edit share class information of a share class, and an instruction to delete a share class, upon which the actions module may be configured to receive share class information for a new share class, edit share class information, and delete the share class, respectively.

The actions module may be configured to receive an input via the user interface of the actions module designating an instruction to view and/or make changes to stock options, upon which the software application may be configured to display, via the user interface of the actions module, at least one of a list of stock options and receive via the user interface an instruction to display stock option information. Stock option information may include, for each stock option, a stock option plan name, share class name, total options issued, a vesting duration, a vesting interval, total options, an issued date, an exercised status, and total remaining option. Stock option information may further include, for each holder of options, a name, number of options issued, exercised price, issue date, expiration date, options vested, options unvested, and exercised options. The actions module may be configured to receive at least one input via the user interface of the actions module designating one or more of an instruction to exercise options of a particular holder of options, an instruction to edit information associated with a particular holder of options, an instruction to issue options of a particular stock option plan, an instruction to edit a stock option plan, and an instruction to delete a stock option plan. Upon receiving the instruction to edit information associated with a particular holder of options, the actions module may be configured to receive at least one input designating one or more of a name, number of options issued, exercised price, issue date, expiration date, options vested, options unvested, and exercised options for the holder of options. Upon receiving the instruction to issue options, the actions module may be configured to receive at least one input designating one or more of holder information (e.g., individual or company name, email, address, phone number, company representative name, email, and position, date of birth, citizenship), an existing contact stored within a database of the system as the holder, a number of options, exercise price, and issue date and add the issued options accordingly. Upon receiving the instruction to edit a stock option plan, the actions module may be configured to receive, via the user interface of the actions module, at least one input designating one or more of plan name, share class, total options, vesting duration, vesting interval, and creation date and update the stock option plan accordingly. Upon receiving the instruction to delete a stock option plan, the actions module may be configured to delete the stock option plan.

The actions module may be configured to receive at least one user input designating an instruction to view and/or make changes to instruments, upon which the actions module may be configured to display, via the user interface, existing instruments, and for each existing instrument, associated one or more of instrument type, instrument name, investor name, share class, status (e.g., unconverted, converted), number of RSUs/SAFEs/notes/warrants, number of converted shares, and conversion date. The actions module may be configured to receive at least one input via the user interface of the organization creation module designating an instruction to edit instrument information of an instrument, an instruction to convert an instrument to equity, and an instruction to delete an instrument. Upon receiving an instruction to edit instrument information of an instrument, the actions module may be configured to receive, via the user interface of the actions module, at least one input designating instrument information and an instruction to save the instrument information and may be configured to save the updated instrument information. Upon receiving an instruction to convert an instrument to equity, the actions module may be configured to receive, via the user interface of the actions module, at least one input designating one or more of conversion date, exercise price, number of SAFEs/convertible notes/warrants/RSUs exercised, conversion method (e.g., valuation cap, discount), post money shares, number of shares issued, and value at conversion and may be configured to convert the instrument to equity. Upon receiving an instruction to delete an instrument, the actions module may be configured to delete the instrument. The actions module may be configured to receive at least one input via the user interface of the actions module designating an instruction to add an instrument, upon which the organization creation module may be configured to receive at least one input via the user interface of the organization creation module designating instrument information. The instrument information depends on an instrument type and may include one or more of an instrument type (e.g., SAFEs, convertible notes, warrants, RSUs), share class (e.g., share class A, B, etc.), investor name, instrument name, investment amount, valuation cap, discount rate, estimated shares, conversion trigger (e.g., next financing round, exit event, maturity, manual override), creation date, interest rate, maturity date, number of warrants, exercise price, expiration date, vesting duration, vesting interval, vesting start date, and number of RSUs.

The activity module maintains a comprehensive record of all actions performed, providing an audit trail for transparency and accountability. In some embodiments, the activity module is configured to automatically associate one or more documents with an action at the time the action is created or executed, including documents uploaded during onboarding, generated by the software application, or identified by the machine learning engine. The activity module may be configured to display, via a user interface of the activity module, at least one of a list of each action performed including an action executed, a date and time of when the action was executed, and a corresponding blockchain transaction ID. The activity module may be configured to receive at least one input designating one or more categories to filter the activity module with, upon which the activity module may be configured to display, via the user interface, only actions executed relating to the one or more categories. The activity module may be configured to receive at least one input designating an instruction to link a document with an action executed, upon which the activity module may be configured to receive, via the user interface, at least one input designating a folder and one or more documents within the folder to link to the action executed. The activity module may be configured to receive at least one input designating an instruction to view a document, upon which the activity module may be configured to display the document. In some embodiments, activity log entries include a cryptographic hash of associated action data and linked documents, enabling later verification of integrity independent of storage location. In some embodiments, executed actions may be reversed or corrected through a subsequent compensating action that preserves a tamper-resistant or append-only audit trail.

The settings module allows users to customize the software application according to their specific requirements, ensuring flexibility and adaptability. The settings module may include a members submodule and a billings submodule. The members submodule may be configured to display, via a user interface of the members submodule, member information of each member (e.g., access type, role type, and name) and receive, via the user interface, at least one input designating an instruction to edit member information of a member and/or an instruction to add or delete a member. Examples of access types include full access and view only and examples of role types include legal, accounting, director/officer, and employee/contractor. Upon receiving the instruction to edit member information of a member, delete a member, and add a new member, the members submodule may be configured to receive, via the user interface, at least one input designating updated member information of a member, delete the member, and receive, via the user interface, at least one input designating member information of the new member, respectively. The member submodule may be configured to save the updated member information of the member and the member information of the new member. The billings submodule may be configured to display, via the user interface of the billings submodule, at least one of billing information (e.g., name and address), payment information (e.g., visa card information), and billing amount. The billings submodule may be configured to receive at least one input via the user interface of the billings submodule designating at least one of an instruction to update billing information and/or payment information and updated billing information and/or payment information.

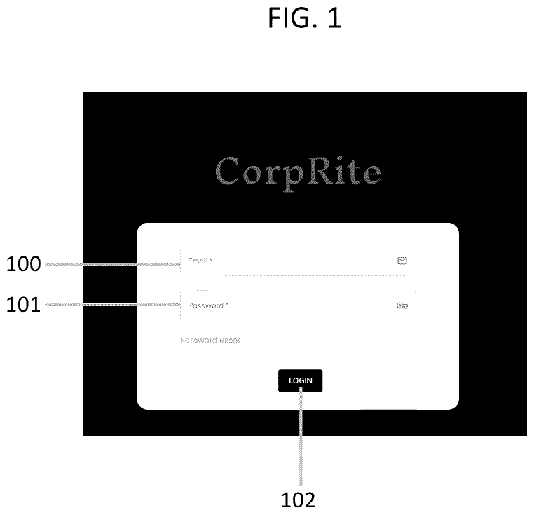

FIG. 1 illustrates an example of a user interface of a login module of a software application configured to receive input designating an email 100, a password 101, and an instruction to login 102. In some embodiments, logging in requires two-factor authentication. In some embodiments, logging in requires a user to agree to accept terms of use and a privacy policy.

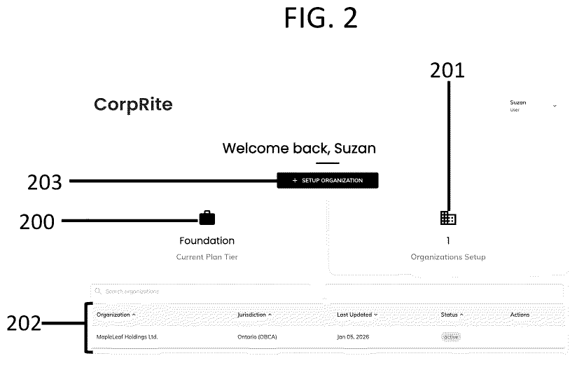

FIG. 2 illustrates an example of a user interface of a homepage module of the software application configured to display a current tier plan 200, a number of organizations created 201, and organizations created and associated information (i.e., jurisdiction, last update date, status, and actions) 202. The user interface of the homepage module is also configured to receive input designating an instruction to create or setup an organization 203.

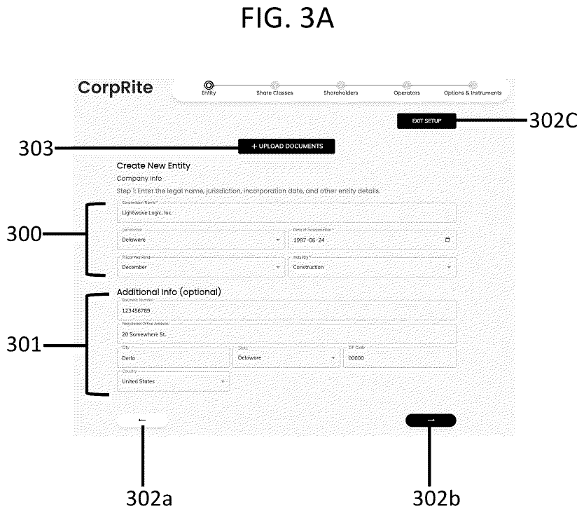

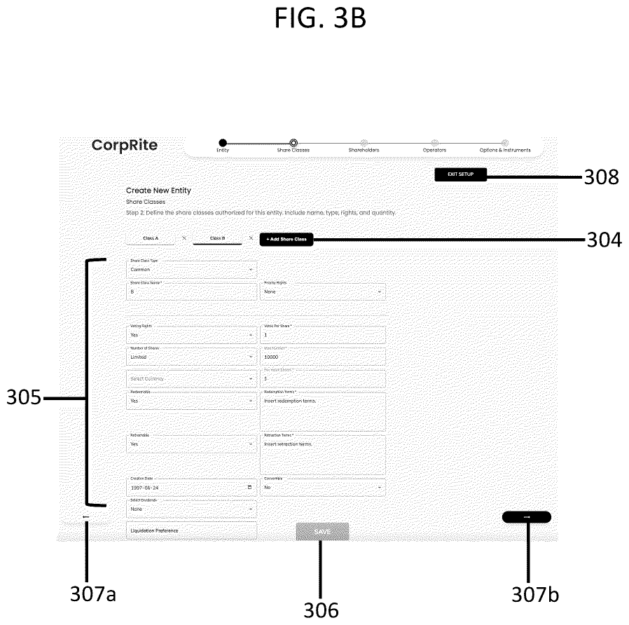

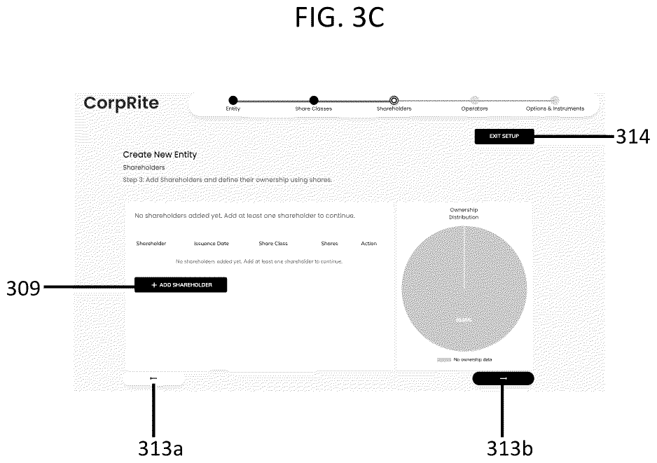

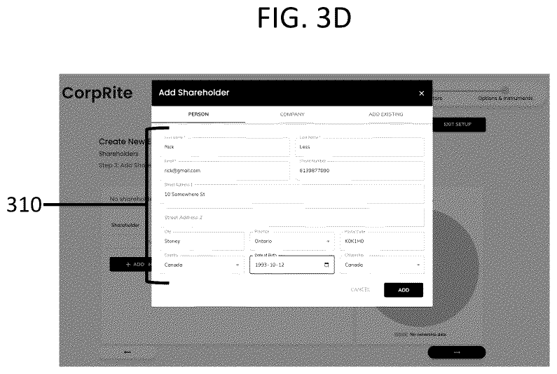

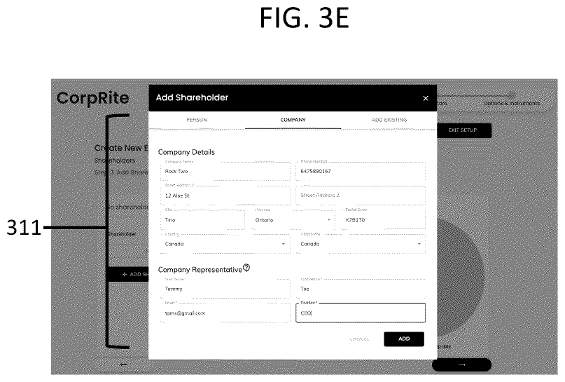

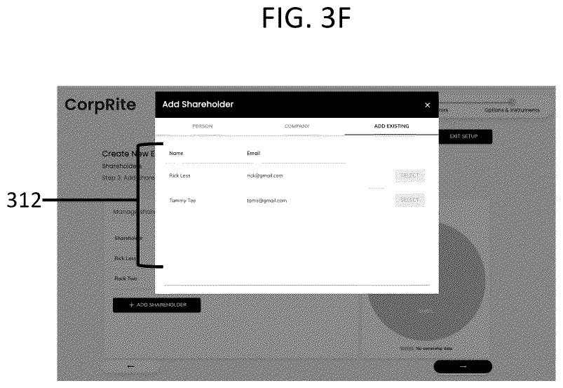

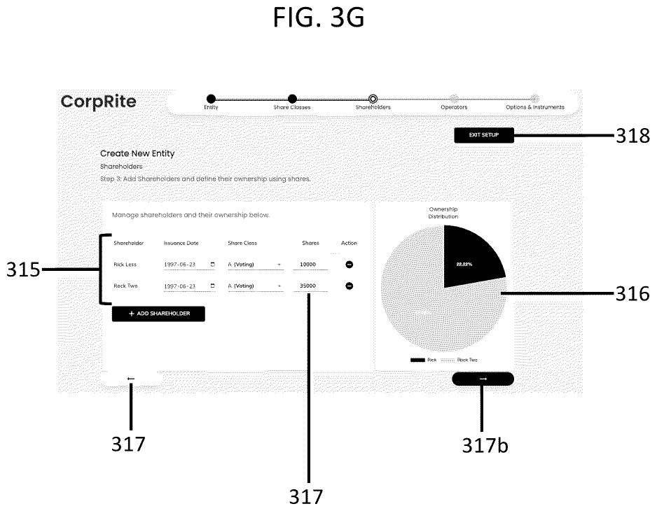

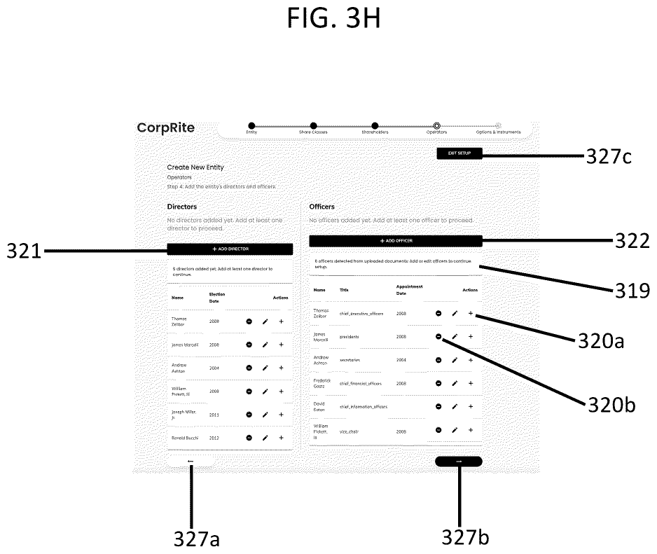

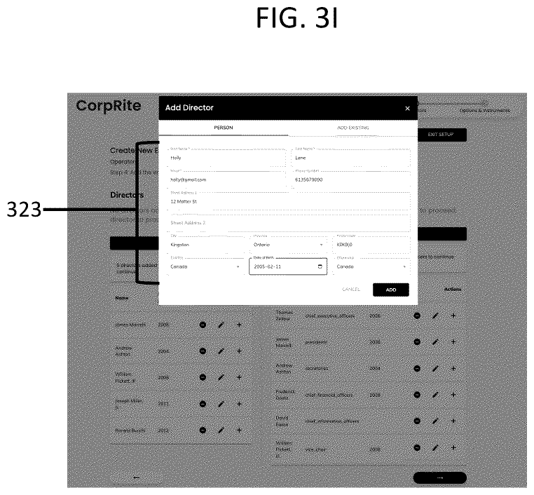

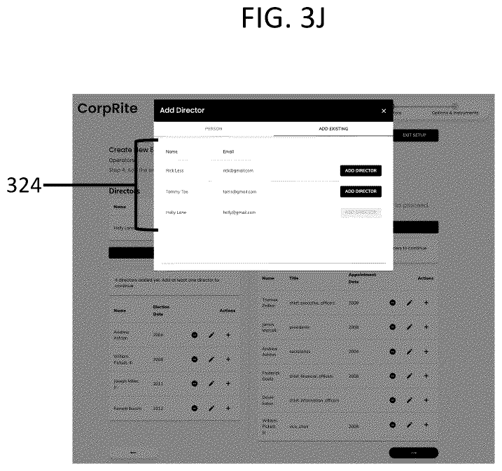

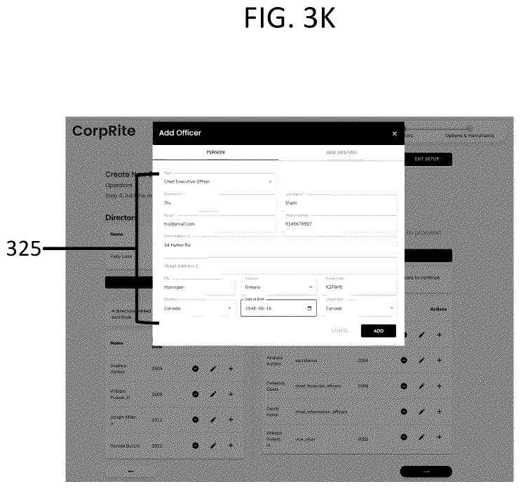

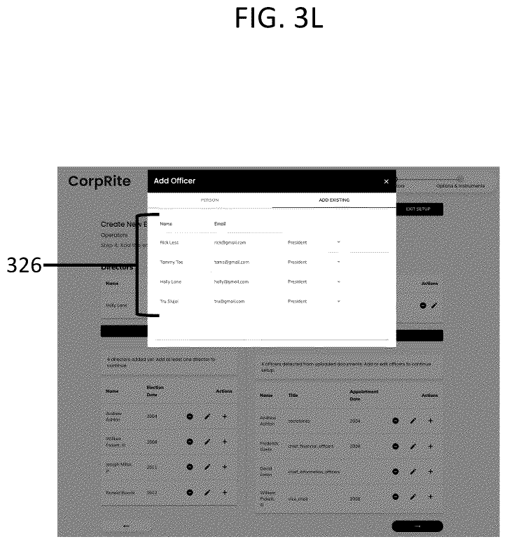

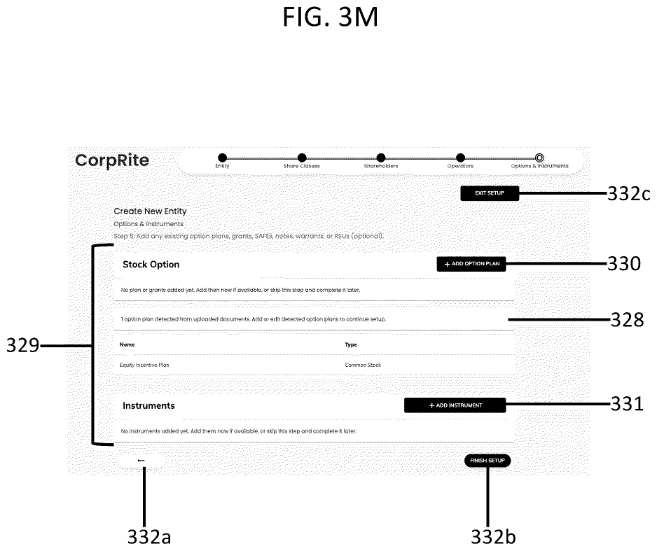

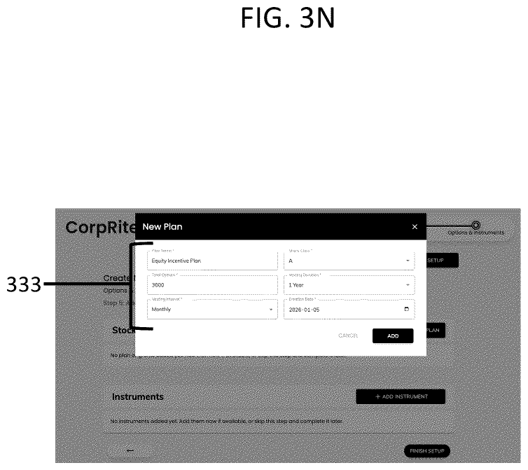

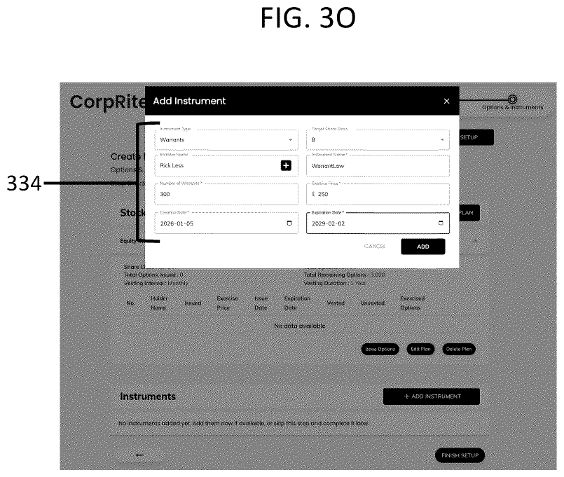

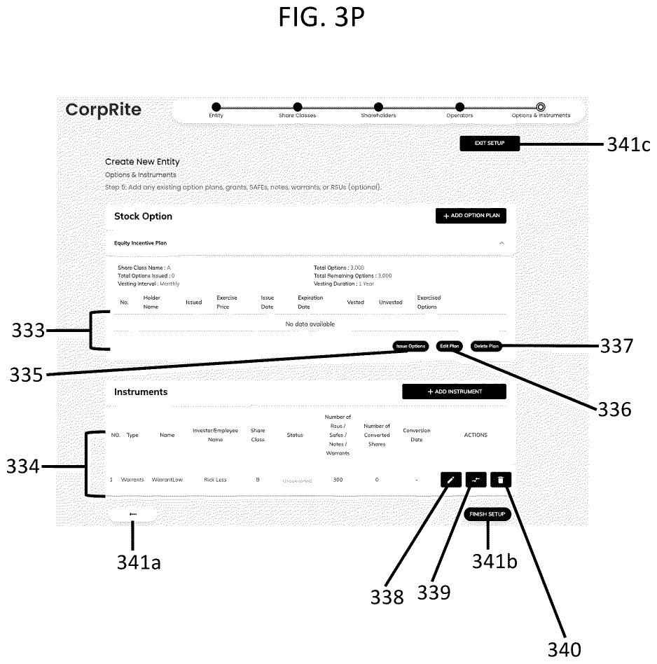

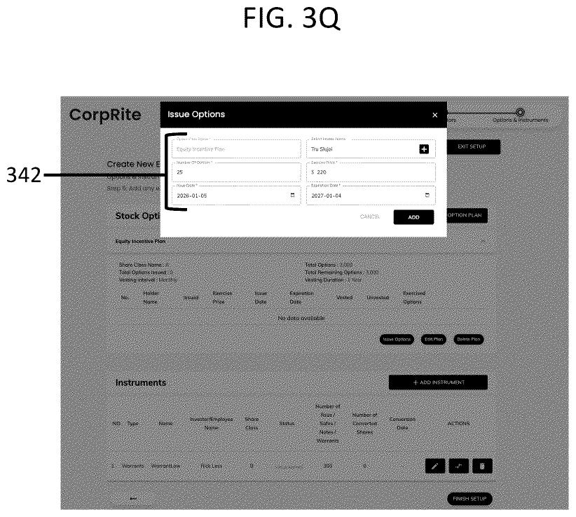

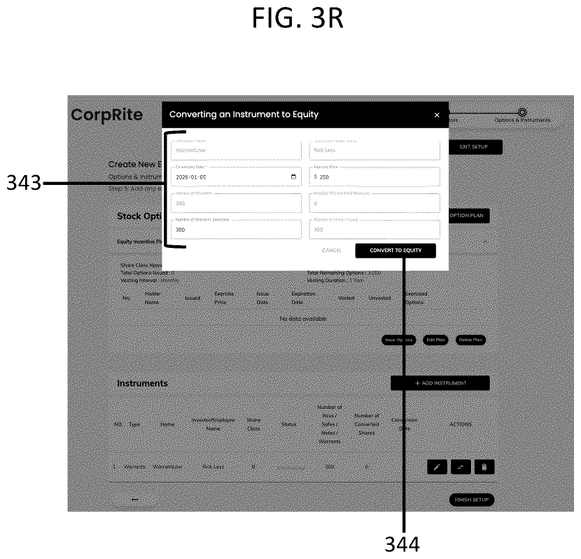

FIGS. 3A-3Q illustrate an example of user interfaces of an organization creation module of the software application. FIG. 3A illustrates, in a first step of creating an organization, a user interface of the organization creation module configured to receive input designating corporate info 300, additional info 301, and an instruction to proceed to a previous step 302a, a next step 302b, or to exit the organization creation module 302c. The user interface of the organization creation module is also configured to receive input designating an instruction to upload corporate documents 303. In such embodiments, the organization creation module extracts information from the uploaded corporate documents and auto populates one or more corporate info 300 and additional info 301. FIG. 3B illustrates, in a second step of creating the organization, the user interface of the organization creation module is configured to automatically extract information from the uploaded corporate documents and auto populate one or more share classes and one or more share class information. In some cases, the organization creation module is configured to display a notification that share classes are detected from the uploaded corporate documents and receive input designating an instruction to confirm or dismiss the share classes detected. Upon confirmation, the organization creation module is configured to auto populate the one or more share classes and the one or more share class information. FIG. 3B also illustrates the organization creation module is configured to receive input designating an instruction to create a new share class 304 share class information of a new share class 305, an instruction to save the new share class 306, an instruction to proceed to a previous step 307a or a next step 307b, and an instruction to exit the organization creation module 308.

FIGS. 3C-3F illustrate, in a third step of creating the organization, the user interface of the organization creation module is configured to automatically extract information from the uploaded corporate documents and auto populate one or more shareholders and one or more shareholder information. In some cases, the organization creation module is configured to display a notification that shareholders are detected from the uploaded corporate documents and receive input designating an instruction to confirm or dismiss the shareholders detected. Upon confirmation, the organization creation module is configured to auto populate the one or more shareholders and the one or more shareholder information. FIGS. 3C-3F also illustrate the organization creation module configured to receive input designating an instruction to add a new shareholder 309, individual shareholder information 310 of the new shareholder, company shareholder information 311 of the new shareholder, and a selection of an existing contact 312 as the new shareholder, respectively. FIG. 3C is also configured to receive an instruction to proceed to a previous step 313a or a next step 313b and an instruction to exit the organization creation module 314. FIG. 3G illustrates, in the third step of creating the organization, the user interface of the organization creation module configured to display shareholder information in table form 315 and graph form 316. FIG. 3G illustrates, in the third step of creating the organization, the user interface of the organization creation module configured to receive input designating an instruction to proceed to a previous step 317a or a next step 317b, and an instruction to exit the organization creation module 318.

FIGS. 3H-3L illustrate, in a fourth step of creating the organization, the user interface of the organization creation module configured to automatically extract information from the uploaded corporate documents and auto populate one or more directors, one or more director information for a director, one or more officers, and one or more officer information for an officer. In this case, the organization creation module is configured to display a notification 319 that directors and/or officers are detected from the uploaded corporate documents and receive input designating an instruction to add 320a or dismiss 320b the directors and/or officers detected. Upon confirmation, the organization creation module is configured to auto populate the directors and officers. FIGS. 3H-3L also illustrate the organization creation module configured to receive input designating an instruction to add a new director 321 or officer 322, individual director information 323 of the new director, a selection of an existing contact 324 as the new director, individual officer information 325 of the new officer, and a selection of an existing contact 326 as the new officer, respectively. FIG. 3H illustrates, in the fourth step of creating the organization, the user interface of the organization creation module configured to receive input designating an instruction to proceed to a previous step 327a, a next step 327b, or exit the organization creation module 327c.

FIG. 3M illustrates, in a fifth step of creating the organization, the user interface of the organization creation module configured to automatically extract information from the uploaded corporate documents and auto populate one or more option plans, options information for each option plan, one or more instruments, and instrument information for each instrument. In this case, the organization creation module is configured to display a notification 328 that options plans and/or instruments are detected from the uploaded corporate documents and receive input designating an instruction to add or dismiss the option plans and/or instruments detected. Upon confirmation, the organization creation module is configured to auto populate the option plans and instruments. FIG. 3M also illustrates the organization creation module configured to display options and instruments information 329 and receive at least one input designating an instruction to add a new option plan 330, an instruction to add a new instrument 331, an instruction to proceed to a previous step 332a, a next step 332b, or exit the organization creation module 332c. FIGS. 3N and 3O illustrate, in the fifth step of creating the organization, the user interface of the organization creation module configured to receive input designating option plan information 333 of the new option plan and instrument information 334 of the new instrument, respectively. FIG. 3P illustrates, in a sixth step of creating the organization, the user interface of the organization creation module is configured to display option plan information 333 and instrument information 334 of new option plans and instruments added and receive input designating an instruction to issue options 335 of an option plan, edit option plan information 336 of an option plan, delete an option plan 337, edit instrument information 338 of an instrument, actuate converting an instrument to equity 339, delete an instrument 340, and proceed to a previous step 341a a next step 341b, or exit the organization creation module 341c. FIG. 3Q illustrates, in the sixth step of creating the organization, the user interface of the organization creation module configured to display option issuing information 342 for issuing options and receive input designating the option information 342. FIG. 3R illustrates, in the sixth step of creating the organization, the user interface of the organization creation module configured to display instrument conversion information 343 of an instrument actuated for conversion to equity and receive input designating instrument conversion information 343 and an instruction to convert to equity 344.

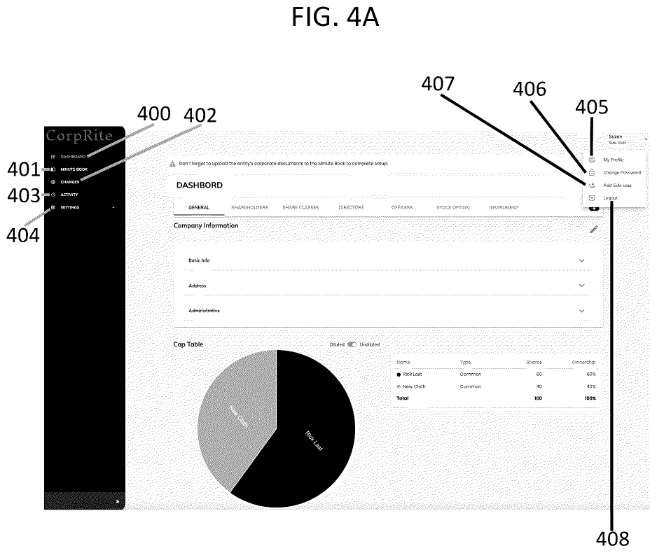

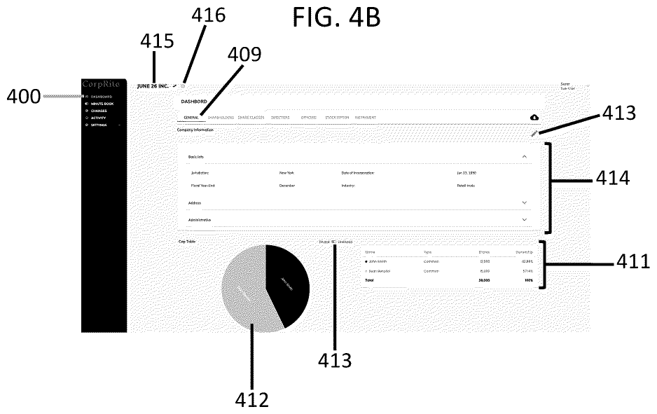

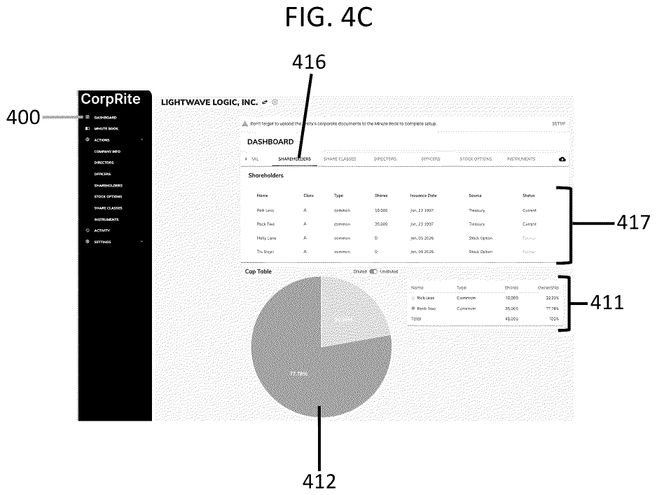

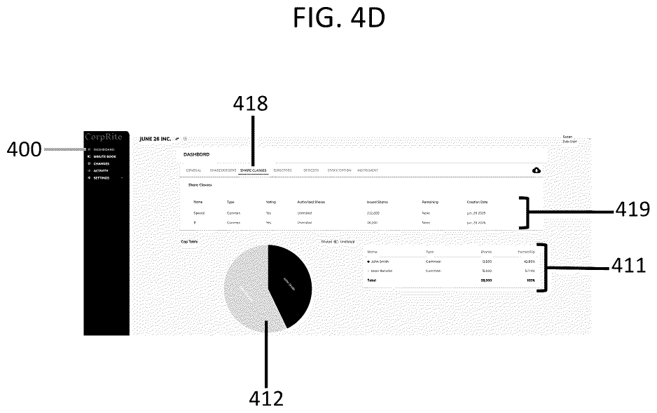

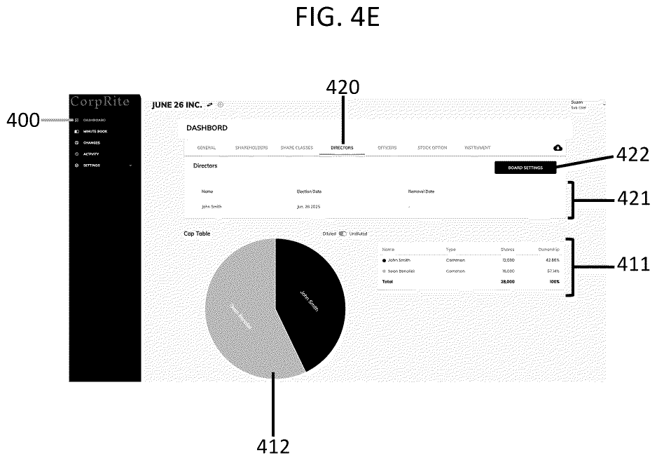

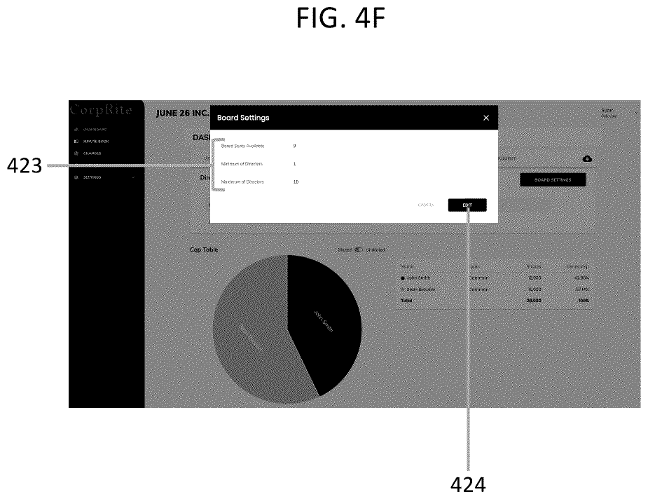

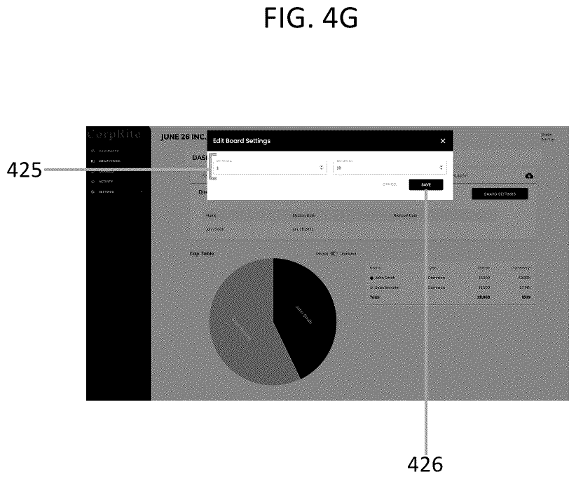

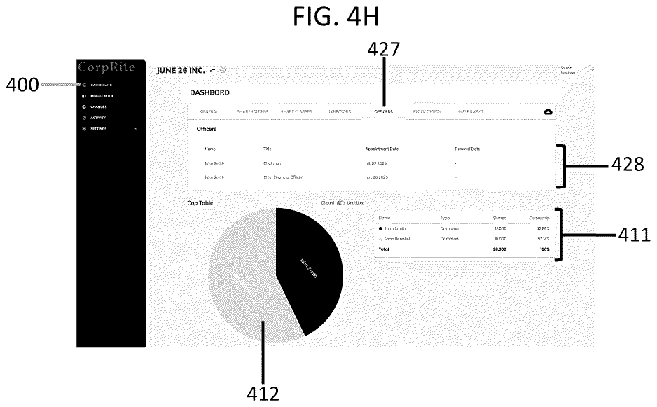

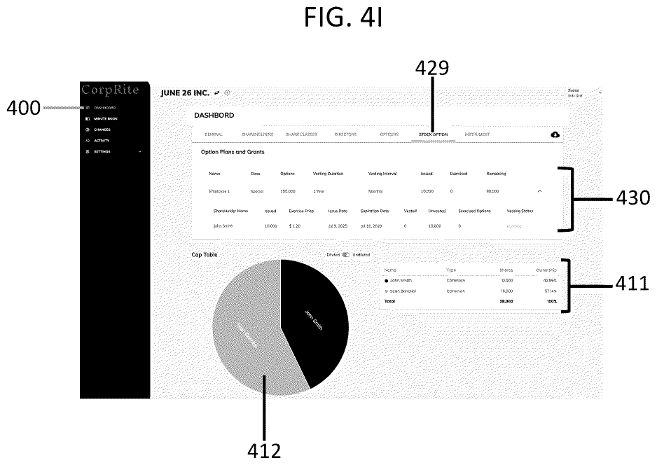

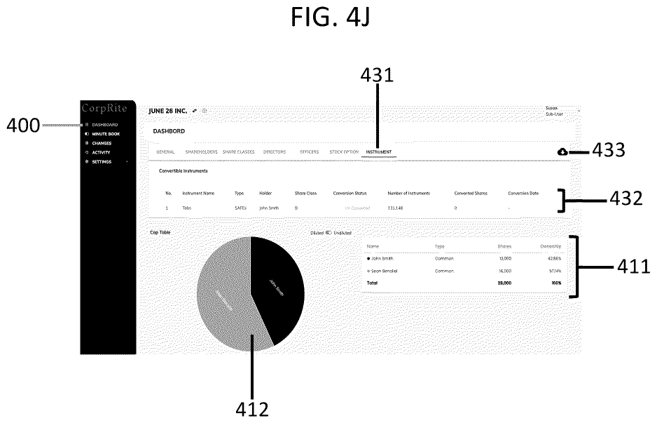

FIG. 4A illustrates an example of a user interface of a profile module of the software application for a particular organization configured to receive input designating an instruction to launch a dashboard module 400, a minute book module 401, an actions module 402, an activity module 403, and a settings module 404. The profile module is further configured to receive input designating an instruction to view a profile of a user 405 (from which profile details may be updated), an instruction to change a password 406, an instruction to add a sub-user 407, and an instruction to logout 408.

FIG. 4B illustrates a user interface of the dashboard module 400 upon receiving input via the user interface of the dashboard module 400 designating an instruction to launch a general information submodule 409, the user interface displaying general organization information 410 and a cap table 411 and chart 412. The user interface of the dashboard module 400 is configured to receive input designating an instruction to display the cap table 411 and chart 412 as diluted or undiluted 413, an instruction to edit organization information 414, an instruction to switch to another organization 415, and an instruction to create a new organization 416. FIG. 4C illustrates a user interface of the dashboard module 400 upon receiving input via the user interface of the dashboard module 400 designating an instruction to launch a shareholders submodule 416, the user interface displaying shareholder information 417 and the cap table 411 and chart 412. FIG. 4D illustrates a user interface of the dashboard module 400 upon receiving input via the user interface of the dashboard module 400 designating an instruction to launch a share classes submodule 418, the user interface displaying share classes information 419 and the cap table 411 and chart 412. FIG. 4E illustrates a user interface of the dashboard module 400 upon receiving input via the user interface of the dashboard module 400 designating an instruction to launch a directors submodule 420, the user interface displaying director information 421 and the cap table 411 and chart 412. The user interface of the dashboard module 400 is configured to receive input designating an instruction to view board settings 422. FIG. 4F illustrates the user interface of the dashboard module 400 upon receiving input via the user interface of the dashboard module 400 designating the instruction to view board settings 423. The user interface of the dashboard module 400 is configured to receive input designating an instruction to edit board settings 424, upon which the user interface of the dashboard module 400 is configured to receive input designating board settings information 425 and an instruction to save the board setting information 426, as illustrated in FIG. 4G. FIG. 4H illustrates a user interface of the dashboard module 400 upon receiving input via the user interface of the dashboard module 400 designating an instruction to launch an officers submodule 427, the user interface displaying director information 428 and the cap table 411 and chart 412. FIG. 4I illustrates a user interface of the dashboard module 400 upon receiving input via the user interface of the dashboard module 400 designating an instruction to launch stock option submodule 429, the user interface displaying director information 430 and the cap table 411 and chart 412. FIG. 4J illustrates a user interface of the dashboard module 400 upon receiving input via the user interface of the dashboard module 400 designating an instruction to launch instrument submodule 431, the user interface displaying instrument information 432 and the cap table 411 and chart 412. The user interface of all submodules of 409, 416, 418, 420, 427, 429, and 431 are configured to receive input designating at least one of an instruction to download a report 433 including one or more of the information associated with submodules 409, 416, 418, 420, 427, 429, and 431 and an instruction to only include particular types of information in the report.

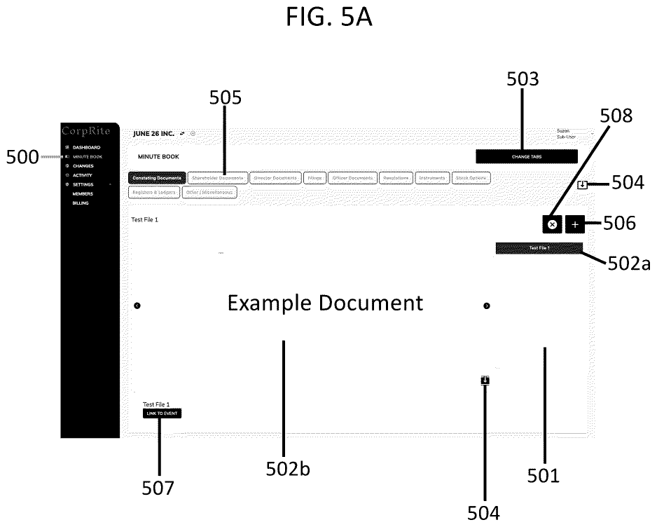

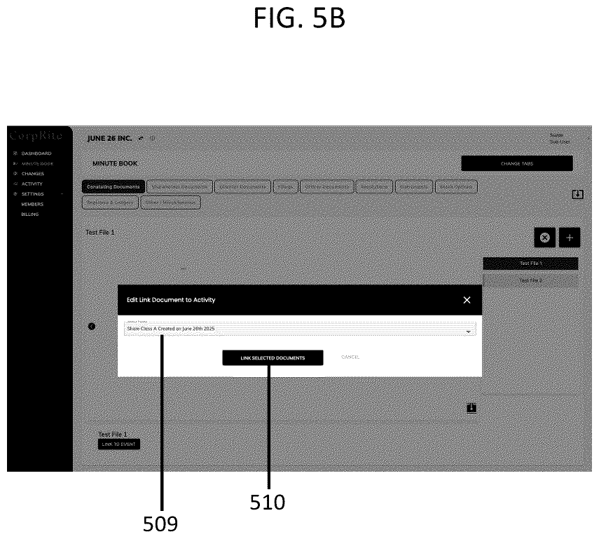

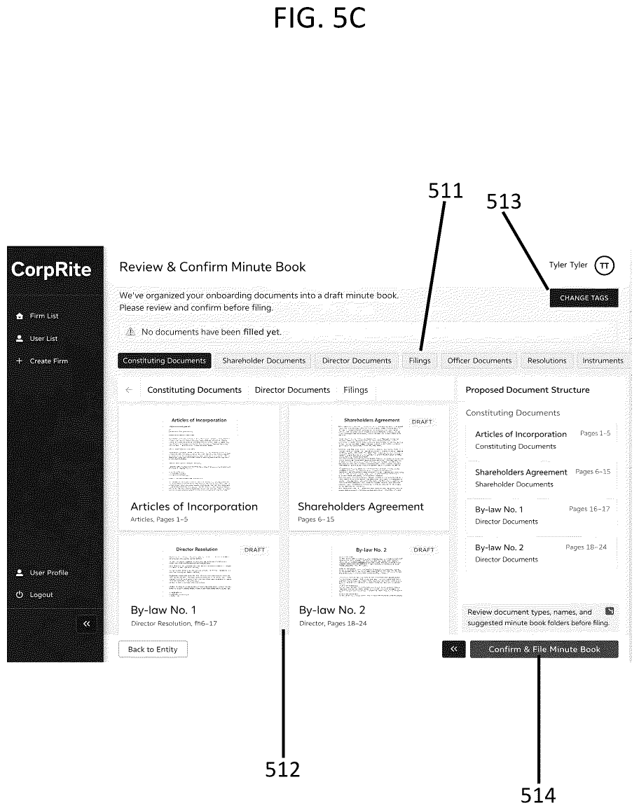

FIG. 5A illustrates an example of a user interface of a minute book module 500 of the software application configured to display a list of documents 501 and receive input designating an instruction to view a particular document 502a upon which the particular document is previewed 502b, an instruction to display a particular category of documents 503, an instruction to download one or more documents 504 (all or of the particular category), an instruction to view documents within a particular folder 505, an instruction to add a new document 506, an instruction to link the particular document to an activity 507, and an instruction to delete the particular document 508. FIG. 5B illustrates an example of a user interface of the minute book module 500 of the software application upon receiving input designating an instruction to link a particular document to an activity, configured to receive input designating an activity 509 to which the particular document is to be linked and an instruction to proceed with linking the particular document with the selected activity 510. FIG. 5C illustrates an example of a user interface of the minute book module 500 of the software application in the case of AI-driven minute book generation. In particular, a customized machine learning algorithm automatically suggests categories or folders 511 for uploaded corporate documents 512, of which the user interface of the minute book module 500 is configured to display. A user may review the category or folder for each corporate document via the user interface of the minute book module. The user interface of the minute book module is configured to receive input designating a new category or folder for a particular corporate document 513. The user interface of the minute book module is further configured to receive input designating an instruction to confirm and file the minute book 514, upon which the minute book module is configured to file the minute book.

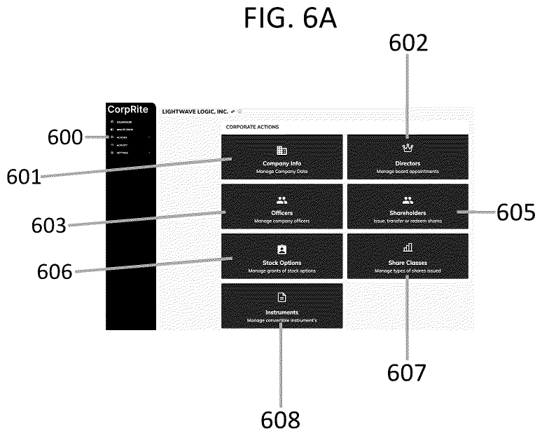

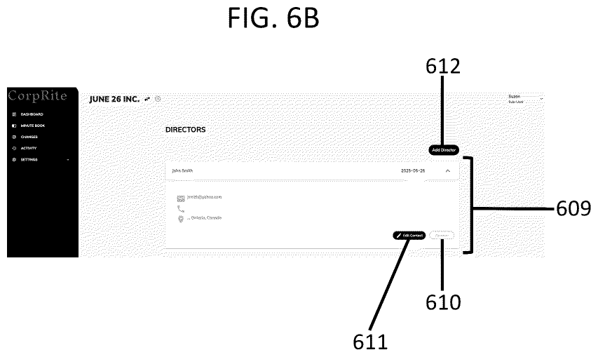

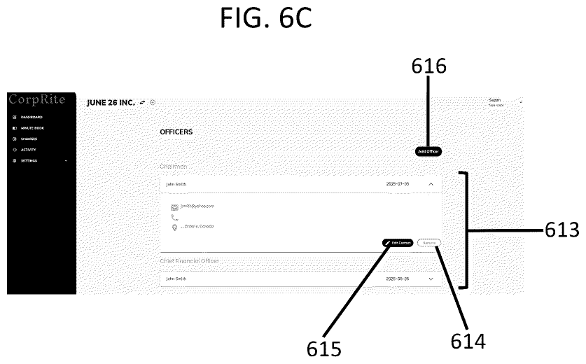

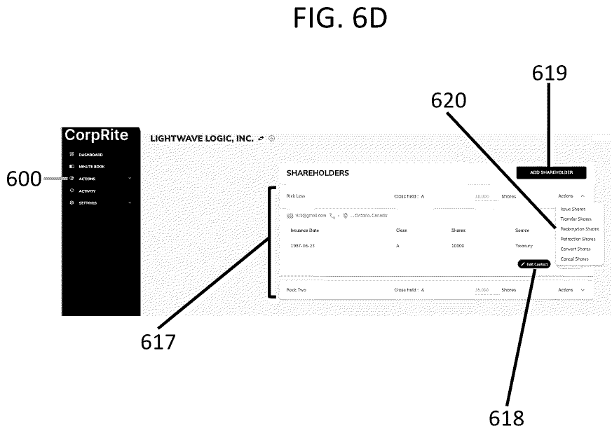

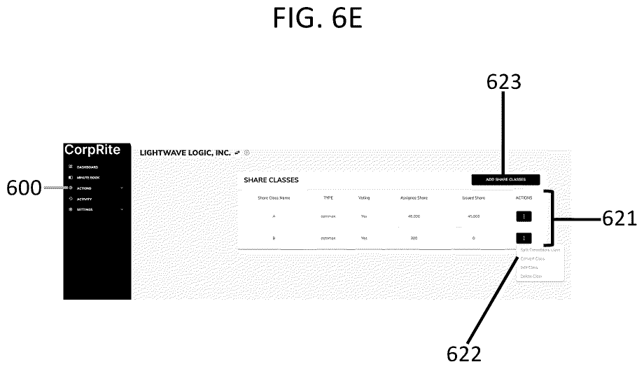

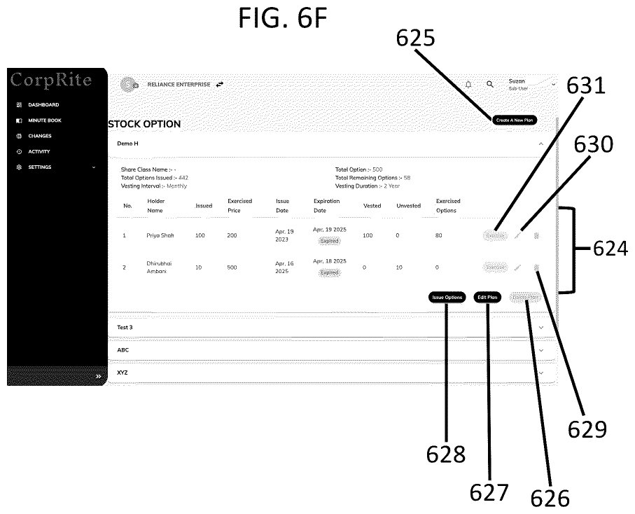

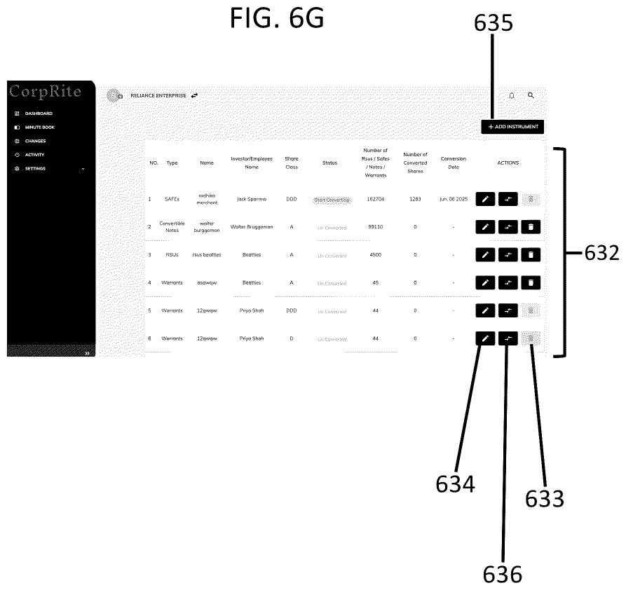

FIG. 6A illustrates an example of a user interface of an actions module 600 of the software application configured to receive input designating an instruction to view and/or make changes to company information 601, directors 602, officers 603, shareholders 605, stock options 606, share classes 607, and instruments 608. FIG. 6B illustrates a user interface of the actions module 600 displaying existing director information 609 upon receiving, via the user interface, the instruction to view and/or make changes to the directors 602. The user interface of the actions module 600 is configured to receive user input designating an instruction to delete an existing director 610, edit director information of an existing director 611, and add a new director 612, upon which the user interface of the actions module 600 is configured to delete the existing director, receive input designating updated director information of the existing director, and receive input designating director information of the new director, respectively. The actions module 600 is configured to save the updated director information of the existing director and the director information of the new director. FIG. 6C illustrates a user interface of the actions module 600 displaying existing officer information 613 upon receiving, via the user interface, the instruction to view and/or make changes to the officers 603. The user interface of the actions module 600 is configured to receive user input designating an instruction to delete an existing officer 614, edit officer information of an existing officer 615, and add a new officer 616, upon which the user interface of the actions module 600 is configured to delete the existing officer, receive input designating updated officer information of the existing officer, and receive input designating officer information of the new officer, respectively. The actions module 600 is configured to save the updated officer information of the existing officer and the officer information of the new officer.

FIG. 6D illustrates a user interface of the actions module 600 displaying existing shareholder information 617 upon receiving, via the user interface, the instruction to view and/or make changes to the shareholders 605. The user interface of the actions module 600 is configured to receive user input designating an instruction to edit shareholder information of an existing shareholder 618, add a new shareholder 619, and an instruction to execute one of a plurality of actions (i.e., issue shares, transfer shares, redemption shares, retraction shares, convert shares, cancel shares) 620, upon which the user interface of the actions module 600 is configured to receive input designating updated shareholder information of the existing shareholder, receive input designating shareholder information of the new shareholder, and receive at least one input required to execute the selected action, respectively. The actions module 600 is configured to save the updated shareholder information of the existing shareholder and the shareholder information of the new shareholder. FIG. 6E illustrates a user interface of the actions module 600 displaying existing share class information 621 upon receiving, via the user interface, the instruction to view and/or make changes to the share classes 607. The user interface of the actions module 600 is configured to receive user input designating an instruction to execute one of a plurality of actions (i.e., delete an existing share class, edit share class information of an existing share class, convert an existing share class, and split consolidate an existing share class) 622 and add a new share class 623, upon which the user interface of the actions module 600 is configured to receive at least one input required to execute the selected action and receive input designating share class information of the new share class, respectively. The actions module 600 is configured to save the updated share class information of the existing share class and the share class information of the new share class.

FIG. 6F illustrates a user interface of the actions module 600 displaying existing stock option information 624 upon receiving, via the user interface, the instruction to view and/or make changes to the stock options 605. The user interface of the actions module 600 is configured to receive user input designating an instruction add a new stock option 625, an instruction to delete an existing stock option 626, edit stock option information of an existing stock option 627, and issue options for an existing stock option 628, upon which the user interface of the actions module 600 is configured to receive input designating stock option information of a new stock option, delete the existing stock option, receive input designating updated stock option information of the existing stock option, and receive input designating options information required for issuing new options, respectively. The actions module 600 is configured to save the updated stock options information of the existing stock option and issue the options upon receiving the information required for issuing the new options. For each stock option, the user interface of the actions module 600 is configured to receive user input designating an instruction to delete a holder of options 629, edit stock option information of a particular holder of options 630, and exercise options of a particular holder of options 631, upon which the user interface of the actions module 600 is configured to delete the existing holder of options, receive input designating updated stock option information of the existing holder of options, and receive input designating exercise information required for exercising options, respectively. The actions module 600 is configured to save the updated stock options information of the existing holder of options and exercise the options upon receiving the information required for exercising the options.

FIG. 6G illustrates a user interface of the actions module 600 displaying existing instrument information 632 upon receiving, via the user interface, the instruction to view and/or make changes to the instruments 606. The user interface of the actions module 600 is configured to receive user input designating an instruction to delete an existing instrument 633, edit instrument information of an existing instrument 634, add a new instrument 635, and convert equity 636, upon which the user interface of the actions module 600 is configured to delete the existing instrument, receive input designating updated instrument information of the existing instrument, receive input designating instrument information of the new instrument, and receive input designating information required to execute the equity conversion, respectively. The actions module 600 is configured to save the updated instrument information of the existing instrument and the instrument information of the new instrument and execute the equity conversion upon receiving the information required for executing the equity conversion.

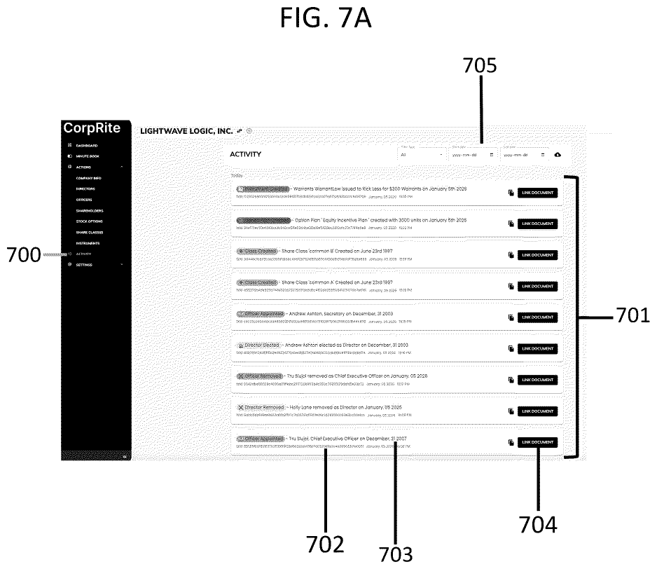

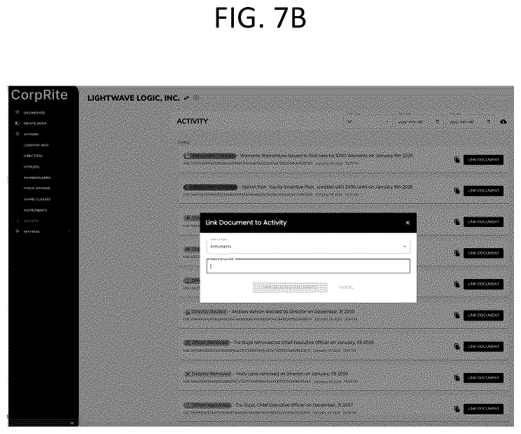

FIG. 7A illustrates an example of a user interface of an activity module 700 of the software application whereby a record of all actions 701 performed (e.g., new shares issued or signature of a particular document) and, for each action, the corresponding blockchain transaction ID 702 and date and time 703 during which the respective action was performed are displayed. The user interface of the activity module 700 is configured to receive input designating an instruction to link a document with a particular action 704 and an instruction to filter the displayed actions by category, start date, and end date 705. FIG. 7B illustrates the user interface of the activity module 700 upon receiving an instruction to link a document to an activity 704, configured to receive input designating a document to which the activity is to be linked.

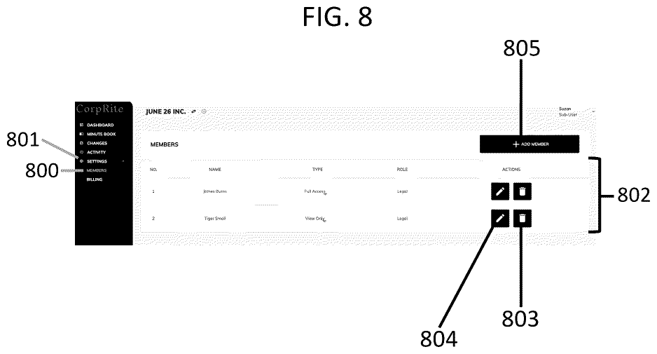

FIG. 8 illustrates an example of a user interface of a members submodule 800 of a settings module 801 of the software application configured to display members information 802. The user interface of the members submodule 800 is configured to receive user input designating an instruction to delete an existing member 803, edit member information of an existing member 804, and add a new member 805, upon which the user interface of the members submodule 800 is configured to delete the existing member, receive input designating updated member information of the existing member, and receive input designating member information of the new member respectively. The members submodule 800 is configured to save the updated member information of the existing member.

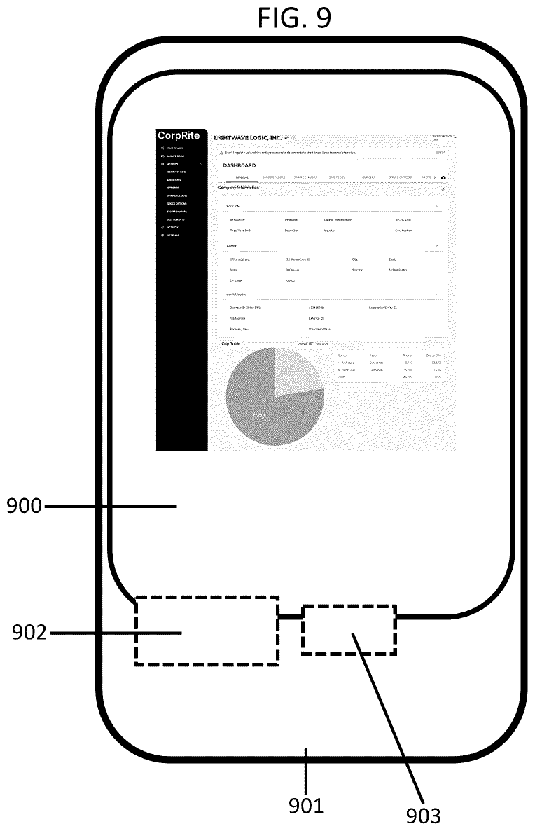

FIG. 9 illustrates an example of a user interface 900 of a dashboard module of a software application executed by a communication device 901. FIG. 9 also illustrates internal components of the communication device 901, including at least a processor 902 and a memory 903.

In some embodiments, blockchain technology is integrated within the software application to create an auditable and unalterable ledger of critical corporate data (e.g., company details, shareholder information, minute book records, equity movements, etc.). A blockchain framework, namely Hyperledger Fabric, is integrated within the software application. Unlike public blockchains, Hyperledger Fabric is a permissioned blockchain, wherein only authorized users can join the network and access/modify the ledger. The Hyperledger Fabric provides a fine-grained access control mechanism to ensure that only authorized users can access specific parts of the software application. This is achieved using a combination of digital certificates, PKI infrastructure, and access control lists. The Hyperledger Fabric uses strong cryptographic algorithms to ensure the confidentiality and integrity of data at rest and in transit over a network. The Hyperledger Fabric uses a consensus mechanism to ensure that all nodes on the network agree on the current state of the ledger, making the software application resistant to attacks and ensuring the validity of transactions.

The Hyperledger Fabric supports the execution of smart contracts, which automatically enforce the rules and regulations based on predefined logic encoded in the smart contracts (e.g., rules stipulated in a shareholders agreement). Smart contracts to automatically execute predefined actions, such as dividend distributions, voting procedures, filing reminders, issuing shares, and compliance checks/tracking based on governance rules and predefined conditions encoded in the smart contracts, thereby reducing the need for intermediaries and manual interventions. For example, voting procedures may be automatically executed based on a board resolution or a shareholder meeting requirement, with ballots tailored to share class rights and quorum rules while filing reminders may be automatically executed based on jurisdiction-specific timelines tied to entity type and prior filing history. Compliance checks may monitor for missing documents, inconsistencies with public registries, and/or expired officer terms. In some embodiments, smart contracts automatically initiate and execute corporate actions, such as Simple Agreement for Future Equity (SAFE) conversions, equity issuance, and board approvals based on predefined logic encoded in the smart contracts, such as predefined triggers that initiate such corporate actions. In one embodiment, the predefined trigger of an execution of a board resolution initiates the corporate action of an automatic issuance of equity or stock options, whereby once a board signs and approves the board resolution authorizing equity grants, tokenized issuance and cap table updates are automatically executed actions. In one embodiment, the predefined trigger of a SAFE or convertible note reaching maturity or a valuation cap threshold initiates the corporate action of an automatic conversion into equity, whereby upon maturity date or valuation event (e.g., priced round), conversion term calculations and cap table updates are automatically executed actions. In one embodiment, the predefined trigger of a filing deadline approaching (e.g., annual return due in 30 days) initiates the corporate action of automatically sending a filing reminder and auto-populating documents, whereby based on jurisdiction-specific requirements and entity calendar, reminders are sent and filings are staged. In one embodiment, the predefined trigger of a new officer or director added without a registry update initiates the corporate action of an automatic registry update, whereby a discrepancy between internal records and public registry prompts automated preparation and filing. In one embodiment, the predefined trigger of a scheduled shareholder vote initiates the corporate action of distributing voting materials and ballots, whereby upon a vote being created, meeting notices and voting templates are autogenerated based on share class rules and distributed. In one embodiment, the predefined trigger of a document signed by required parties (e.g., shareholders agreement) initiates the corporate action of storing in a tamper-resistant or append-only manner the document and linking the document to the ledger and parties, whereby upon a document receiving all signatures, the document is stored in the minute book and logged on the blockchain. In one embodiment, the predefined trigger of an employee's vesting milestone being reached initiates the corporate action of making options exercisable, whereby a vesting schedule triggers a release of options or notification to exercise. In one embodiment, the predefined trigger of a threshold breach in compliance score or governance risk initiates the corporate action of a compliance alert and a recommendation of corrective action, whereby the trained machine learning engine detects gaps (e.g., outdated minute book) and suggests corrective actions (e.g., backdated resolution).

The Hyperledger Fabric provides a secure and private way to store sensitive information as it allows for the storage of private data on the blockchain, which can be accessed only by authorized users. The Hyperledger Fabric provides auditing and monitoring capabilities to track and trace activities on the blockchain, allowing for quick detection and response to any security breaches or anomalies in the software application.

In some embodiments, smart contracts control user access, such as access permissions, signing rights, and action authority, based on predefined logic encoded in the smart contracts. In some embodiments, smart contracts automatically generate resolutions, filings, and notices based on predefined logic encoded in the smart contracts, such as specific legal and/or financial conditions that must be met prior to generating any of resolutions, filings, and notices. Examples of resolutions, filings, and notices that may be generated include director appointment resolutions, shareholder meeting notices, annual report filings, securities regulatory filings (e.g., Form D, 45-106F1), option plan resolutions, KYC compliance notices, reminders for jurisdictional filings (e.g., annual returns or business license renewals), annual return filings (e.g., Ontario Form 1 or Delaware Franchise Tax Report), notices of director or officer changes, articles of amendment, share issuance filings, and registered office updates. Governance-related notices may also be generated, such as board meeting notices, shareholder meeting invitations with proxy forms, option grant notifications, dividend declarations, and reminders for upcoming compliance obligations.

In some embodiments, smart contracts issue shares or convertible instruments as blockchain-based tokens, the tokens representing legal ownership. In some embodiments, investors purchase equity directly using, for example, fiat or crypto, and the smart contracts mint and assign tokens based on the equity purchased, the minted tokens being recorded in a tamper-resistant or append-only manner on the blockchain. In some embodiments, the smart contracts or a module of the software application may be configured to automatically update one or more corporate and/or legal document stored in the database or the minute book module. Examples of corporate or legal documents that may be automatically updated include cap tables, shareholder ledgers, subscription agreements, SAFEs or convertible notes, option grant agreements, board resolutions, share certificates, and regulatory compliance forms. Such corporate and legal documents reflect real-time changes to ownership structure, capitalization, and governance and are automatically updated to ensure consistency across the cap table, minute book, and registry filings. In some embodiments, the activity module automatically updates to maintain a comprehensive record of all actions performed, such as the minting and assignment of tokens. In some embodiments, the software application performs a Know Your Customer (KYC) check to verify the identity of investors and/or an Anti-Money Laundering (AML) regulations check to prevent criminal financial activity prior to issuing blockchain-based tokens. In some embodiments, smart contracts execute transferring shares, redemption, and conversion of shares based on predefined logic encoded in the smart contracts. The predefined logic encoded in the smart contracts may be derived from corporate governance policies, jurisdiction-specific legal requirements, and/or contractual obligations outlined in documents such as shareholder agreements, bylaws, and securities regulations. For example, documents may define rules including quorum thresholds for board or shareholder votes, vesting schedules for equity grants, filing deadlines set by corporate registries, or preemptive rights triggered during financing events. The predefined logic encoded in the smart contracts may apply these rules to determine when and how actions such as share issuances, SAFE conversions, or board approvals should be executed or logged. In some embodiments, the Hyperledger Fabric records in a tamper-resistant or append-only manner equity movements, such as share issuances, transfers, redemptions, and conversions, on the blockchain in real-time, providing a secure and auditable history of all shareholder transactions.

In some embodiments, the software application includes one or more of a contract builder with smart contract capability, a corporate resolution builder with smart contract capability, a contract template shop with smart contract capability, an intellectual property filing system with direct integration with government filing systems, a virtual shareholder and director meeting room with participant voting capabilities, an employee management tool with stock rights and smart contract capability, a module for starting and maintaining other business entities (e.g., limited liability companies, limited partnerships, etc.), and a dedicated portal and/or payment plan for lawyers and accountants.

In some embodiments, a signature engine is integrated within or functions in tandem with the software application. A user interface of the signature engine may be configured to display corporate documents and receiving input designating placement of signature fields. The signature engine may be configured to automatically populate one or more information in corporate documents based on known information (e.g., information saved in corporate profile). The signature engine may further be configured to track a document status (e.g., pending, viewed, signed, complete) and automatically update the minute book module and blockchain ledger upon completion (i.e., signing) of a corporate document. The signature engine may further be configured to trigger updates, such as cap table, registers, and instrument updates.

In some embodiments, the software application includes one or more of a custom AI chatbot (i.e., customized AI computer programming code or algorithm) that provides legal advice/direction, integrated custom AI (i.e., customized AI computer programming code or algorithm) to create and manage organizations (e.g., starting and maintaining corporations, building agreements, corporate resolutions, and advising users), and a smart contract creation/building tool. In some embodiments, the integrated custom AI is trained, validated, and tested, thereby learning to optimize corporate maintenance, corporate management, contract preparation, product advertisement, etc.

In some embodiments, the software application integrates customized AI (e.g., LLM) (i.e., customized AI computer programming code or algorithm). The customized AI is trained, validated, and tested to perform the various AI-driven actions described herein using, for example, machine learning training, validation, and testing methods. In some embodiments, the software application, via the customized AI, automatically determines one or more required documents for a corporate action. In some embodiments, the software application, via the customized AI, drafts legal documents, such as incorporation documents, resolutions, shareholder agreements, option plans, consents, etc. For example, one or more of internally stored data (e.g., governance documents, cap tables, documents saved within the minute book, and user-provided information), predefined templates, and external AI models (e.g., GPT-based systems) trained on corporate law datasets may be used in drafting legal documents. The external AI models may assist in drafting by applying jurisdiction-specific language, identifying gaps, or suggesting clauses. Where needed, the customized AI may also prompt the user, via the software application, with context-driven questions to supplement or validate the information before finalizing a document. The software application may, via the customized AI, validate consistency within a document prior to finalizing the document. In some embodiments, the software application, via the customized AI, automatically saves documents in appropriate folders within the minute book module. In some embodiments, the software application, via the customized AI, automatically links a document with an action.

In some embodiments, the software application, via the customized AI, extracts data from one or more documents saved within the minute book module and uses the extracted data for one or more of generating a cap table, determining director/officer/shareholder details, determining a document timeline, and identifying any legal gaps. Examples of legal gaps may include missing or unsigned board resolutions, outdated shareholder agreements, absent officer/director appointment documents, inconsistencies between registry filings and internal records, and failure to document corporate actions such as option grants or share issuances. Gaps may be identified by analyzing the completeness, consistency, and chronology of documents stored in the minute book module. In some embodiments, the software application may be configured to record the cap table, the director/officer/shareholder details, and/or the document timeline within one or more modules of the software application. In some embodiments, the software application, via the customized AI, may be configured to display, via the user interface, a notification indicating the legal gaps and any suggested actions.

In some embodiments, the software application, via the customized AI, may be configured to execute document organization. In some embodiments, the software application, via the customized AI, automatically classifies and tags uploaded documents and links the uploaded documents with corresponding events/actions. For example, a board resolution document uploaded to the minute book module may be automatically tagged as a ‘Board Approval’ document and linked to the action ‘issuance of stock options’ logged in activity history. In some embodiments, the software application, via the customized AI, flags missing, incorrect, or outdated records, filings, or documents. For example, the software application, via the customized AI, may flag a shareholder agreement as missing upon identifying no shareholder agreement in the minute book module. In another example, the software application, via the customized AI, may flag incorrect documents upon identifying a mismatch between share classes listed in the articles of incorporation and the cap table. In another example, the software application, via the customized AI, may flag outdated documents upon identifying a mismatch between an old address listed in director filings and an address listed in most recent records.

In some embodiments, the software application, via the customized AI, models/simulates a cap table. In some embodiments, the software application, via the customized AI, simulates one or more of funding rounds, pro rata rights, option pool adjustments, and SAFE/convertible conversions. Simulations may rely on one or more of information stored in the system (e.g., existing cap table, share classes, option grants, convertible instruments, investor profiles) and user inputs that may be prompted by the customized AI. For example, to simulate a funding round, the customized AI may use a current share structure and prompt the user for an investment amount, a valuation, and/or discount terms. To model a SAFE conversion, the customized AI may use stored SAFE agreements and trigger conditions such as equity round pricing. Simulations may help forecast dilution, post-money ownership, and cap table adjustments.

In some embodiments, the software application, via the customized AI, generates a risk score, wherein the customized AI evaluates the legal posture of the corporation and highlights compliance issues or inconsistencies. The risk score may reflect the legal and compliance risk of the corporate, specifically, how well the corporation's internal governance, filings, and legal documents align with statutory and regulatory requirements. In some embodiments, the risk score may be determined using a rules-based engine and/or trained machine learning models that assess various data points, such as missing or outdated corporate records, lack of required filings, inconsistencies between a cap table and legal documents, non-compliance with corporate governance requirements (e.g., unsigned resolutions, expired officer terms), and incomplete or missing KYC/AML checks. In some embodiments, the customized AI may weigh the severity and frequency of such issues and assign a composite score reflecting the corporation's legal health and compliance posture.

In some embodiments, the software application, via the customized AI, automatically compiles documents and data for investor or regulatory reviews required for due diligence based on records saved in a database of the system and/or information extracted from public sources. In some embodiments, the software application, via the customized AI, extracts registry data. In some embodiments, the software application, via the customized AI, extracts real-time corporate data from public registries, normalizes and merges the corporate data, detects discrepancies with user-provided information, and suggests updates or filings based on the discrepancies. For example, the software application may extract data from a public registry (e.g., Ontario Business Registry) that indicates Jane Smith as a current director of ABC Inc., however, internal records within the software application indicate Jane Smith resigned six months ago and was replaced by John Doe. The customized AI may detect this discrepancy and suggests: (i) generating a resolution documenting the change; (ii) filing a Form 1—Notice of Change with the registry; and (iii) updating the internal records accordingly. This ensures consistency between public records and the internal minute book and supports regulatory compliance. In some embodiments, registry data is retrieved in real time or near real time, or periodically synchronized based on jurisdictional availability and system configuration.

In some embodiments, the software application, via the customized AI, functions to provide efficient corporate management. For instance, the software application, via the customized AI, identifies missing, incorrect, or outdated documents. The software application may notify the user, and upon approval of the user, a smart contract may be triggered to rectify the issue of the missing, incorrect, or outdated document. For example, the software application, via the customized AI, identifies a missing resolution. The software application displays, via the user interface, a notification that the resolution is missing and one needs to be generated. The software application receives, via the user interface, a user input indicating approval to generate the resolution, triggering a smart contract of the software application to automatically generate the resolution. The generated resolution is signed and filed and the software application updates the auditable and unalterable ledger and the activity module based on the actions taken.

In some embodiments, the software application, in cooperation with the integrated customized AI, supports onboarding of multiple corporations. For instance, multiple minute books and/or corporate documents of various corporations may be supported by the software application within a single user account. the software application, via the customized AI, may connect to public registries and extract real-time corporate data, organize and fill out corporate information of each corporation based on the extracted corporate data and information extracted from minute books and/or corporate documents. The software application, via the customized AI, may further create cap tables, officer lists, and corporation records for each corporation based on information accessible within the software application.

In some embodiments, one or more actions described herein as being performed using AI technology is executed by the software application without the use of AI technology.

In some embodiments, one or more AI-assisted functions described herein are performed using deterministic rules or predefined logic without use of a machine learning model.

In some embodiments, the software application may be configured to work with quantum computing systems. In some embodiments, the software application integrates a blockchain framework with blockchain nodes that are further decentralized from traditional industry sources (e.g., banks, governments, universities, etc.). In some embodiments, the software application implements a blockchain framework or configures the existing blockchain framework described herein particularly for tracking and storing intellectual property rights and assets.

In some embodiments, the software application integrates with one or more of proprietary or third-party financial products (e.g., bank accounts, credit facilities, and private investment vehicles), insurance products (e.g., commercial general liability insurance and related products), payment processing products (e.g., digital and physical payment terminals), accounting and bookkeeping products and services (e.g., bookkeeping, tax filing, etc.), technology products and services (e.g., website builders, software developers, hardware and software products, etc.), and marketing products and services (e.g., online marketing, advertisement services, etc.).

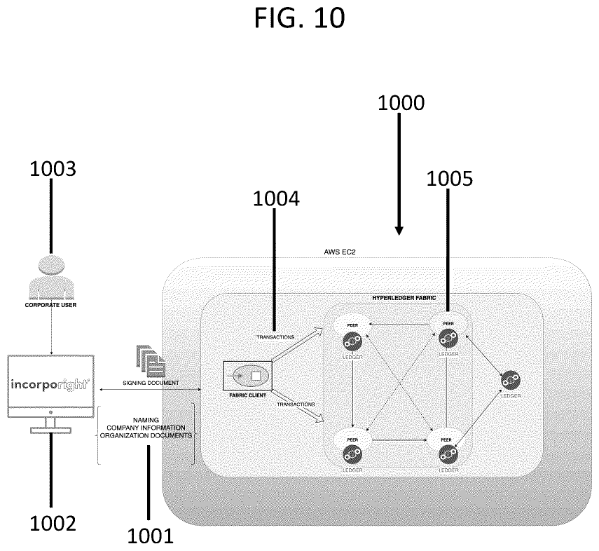

FIG. 10 illustrates a diagram of a Hyperledger Fabric blockchain network 1000 integrated with the software application. Information 1001 provided as input to the software application 1002 by a user 1003 and generated by the software application are provided to the blockchain network 1000 as transaction requests 1004. The blockchain network 1000 approves or rejects the transaction requests after checking details required to authenticate the transactions 1004. Each peer node 1005 performs a particular function, such as validating transactions, maintaining the ledger, and executing chain code (i.e., smart contract). Approved transactions 1004 are recorded in blocks and are transmitted to peer nodes 1005. Each of the peer nodes 1005 update their local ledger 1006 with the block such that the transactions 1004 are committed.

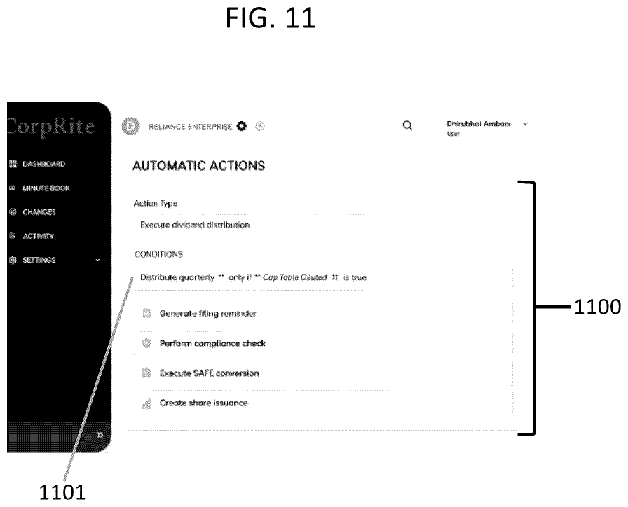

FIG. 11 illustrates an example of a user interface of the software application configured to, via a customized AI encoded within the software application, autonomously execute corporate actions based on predefined governance rules and conditions, as governed by smart contracts integrated with Hyperledger Fabric. The user interface is configured to receive input 1100 designating an instruction to execute actions, with the software application, via the customized AI, verifying compliance conditions 1101 in real-time before execution. Examples of actions include share issuances, dividends, SAFE conversions, stock option grants, share transfers, board approvals, redemptions, share class conversions, equity cancellations, RSU allocations, corporate reorganizations, and director/officer appointments or removals. Upon execution, the software application records in a tamper-resistant or append-only manner the action and its associated data on the blockchain, generating a unique transaction ID for audit and traceability. This interface provides transparent, compliant, and verifiable corporate operations.

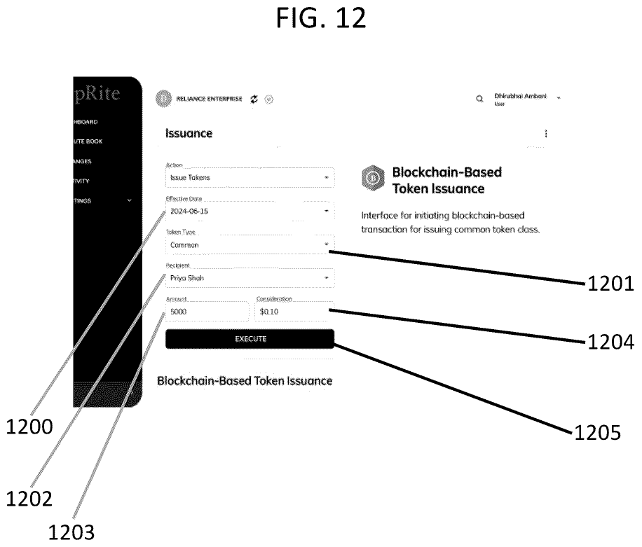

FIG. 12 illustrates an example of a user interface of the software application configured issue equity or convertible instruments as blockchain-backed tokens. Through a guided workflow, the software application is configured to receive, via a user interface of the software application, input designating an effective date 1200, a token type 1201, a recipient 1202, a number of tokens (e.g., shares or SAFEs) 1203, consideration 1204, terms such as vesting schedules or rights (not shown), and an instruction to execute the issuance 1205. Once confirmed, the software application invokes predefined smart contract logic to mint the tokens, records in a tamper-resistant or append-only manner the issuance on the blockchain, and updates a cap table accordingly and the activity module of the software application with the action and associated transaction ID. This interface provides secure, tamper-proof equity issuance with real-time ledger synchronization.

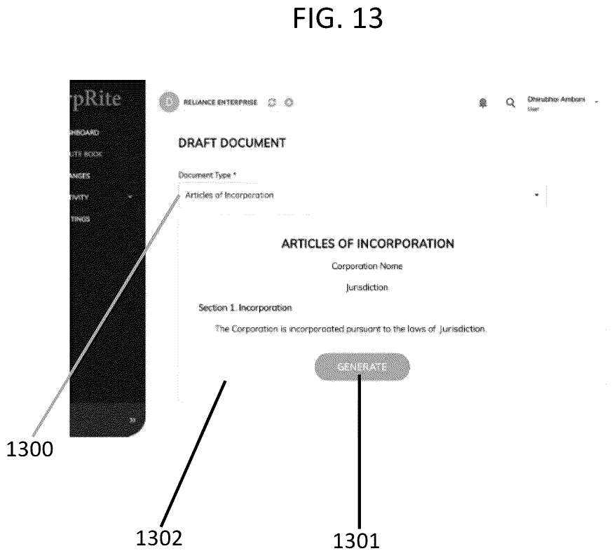

FIG. 13 illustrates an example of a user interface the software application configured to, via a customized AI encoded within the software, autonomously generate documents. The software application is configured to receive, via the user interface, input designating a document type to generate 1300 (e.g., Articles of Incorporation, Resolutions, Shareholder Agreements, Option Plans, and Consents) and an instruction to generate the document 1301, upon which the software application is configured to automatically generate and display a draft 1302 using pre-populated entity data, allowing the user to review the document. The software application is configured to receive, via the user interface, input designating modifications to the document and an electronic signature. The software application is configured to automatically tag documents, store documents within an appropriate folder (e.g., “Constating Documents”), and link documents to relevant corporate events/actions logged in the software application. This functionality supports streamlined corporate documentation through AI-assisted legal drafting.

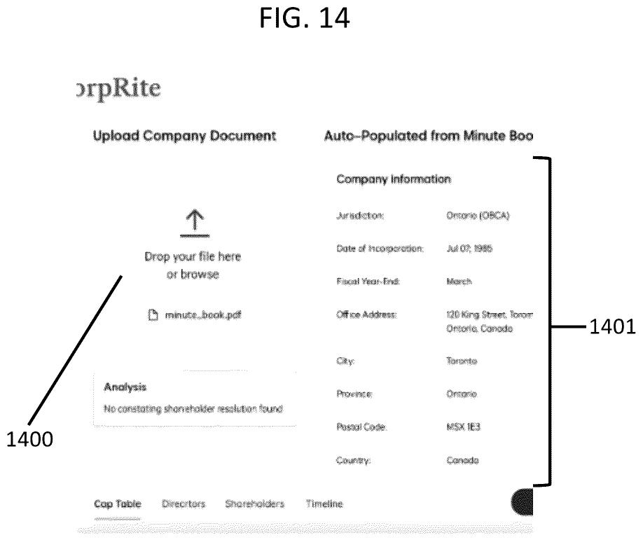

FIG. 14 illustrates an example a user interface of the software application configured to, via a customized AI, automatically populate corporate records based on receiving input designating an instruction to upload particular documents 1400, such as a PDF of a minute book. Upon upload, the software application, via the customized AI, is configured to parse the contents to extract relevant data (e.g., company name, jurisdiction, incorporation date, shareholder and officer details, and fiscal year-end) and intelligently map the data into the appropriate fields 1401 within the software application, eliminating manual entry. This streamlines the setup of entities and reduces human error, while providing accurate and structured data for downstream corporate governance.

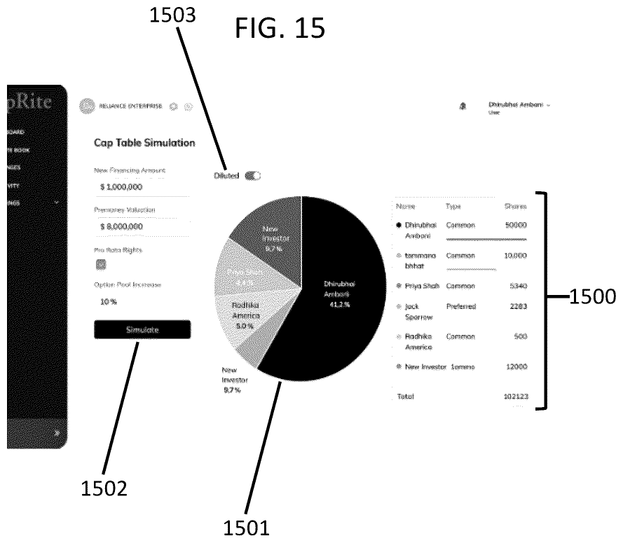

FIG. 15 illustrates an example of a user interface of the software application configured to, via a customized AI, simulate a cap table 1500 and chart 1501 based on receiving inputs 1502 (e.g., new financing amount, pre-money valuation, pro rata right, option pool increase), allowing users to model future equity scenarios in real-time. The software application configured to receive input designating an instruction to illustrate the cap table 1500 and chart 1501 as diluted or undiluted 1503. The software application, via the customized AI, simulates a new funding round based on input such as option pool size and provides an evaluation of the impact of convertible instruments such as SAFEs on ownership distribution. Once configured, the updated cap table is rendered dynamically, reflecting changes to both diluted and undiluted ownership across all stakeholders. This functionality supports strategic planning and compliance by helping users visualize how ownership structures evolve over time under various conditions.

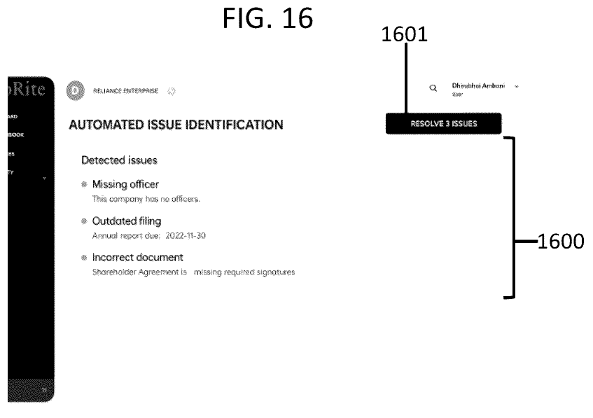

FIG. 16 illustrates an example of a user interface of a software application configured to, via a customized AI, autonomously and actively identify corporate records and filings that are missing, incorrect, or outdated 1600. The software application, via the customized AI, is configured to scan a digital minute book and display, via the user interface, flagged items such as unsigned resolutions, outdated officer information, or missing annual returns. Each item is accompanied by a status tag (e.g., Missing, Outdated, Requires Signature) and a suggested corrective action. This functionality helps users maintain accurate and up-to-date records, reduce risk of non-compliance, and streamline corporate governance by surfacing issues and recommending next steps. The user interface of the software application is configured to receive user input designating an instruction to resolve the displayed flagged items 1601, upon which the user interface is configured to elaborate further on each flagged item or explain and/or actuate actions to resolve each flagged item.

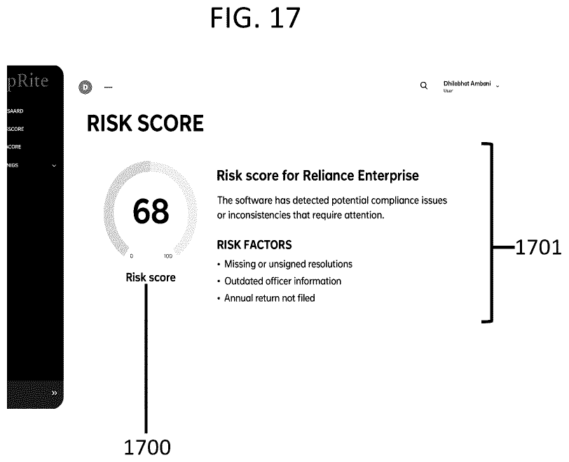

FIG. 17 illustrates an example of a user interface of the software application configured to, via a customized AI, generate a risk score which evaluates a legal posture of the organization in real-time. The software application is configured to, via the customized AI, analyze key compliance indicators, such as missing filings, outdated officer information, and unexecuted resolutions, and generate a risk score. The user interface of the software application is configured to display the risk score 1700 and a breakdown panel 1701 that highlights specific issues contributing to the risk score 1700, with visual indicators (e.g., red, yellow, green) and suggested remediation actions. This feature empowers users to proactively address legal risks and maintain good standing with regulatory authorities.

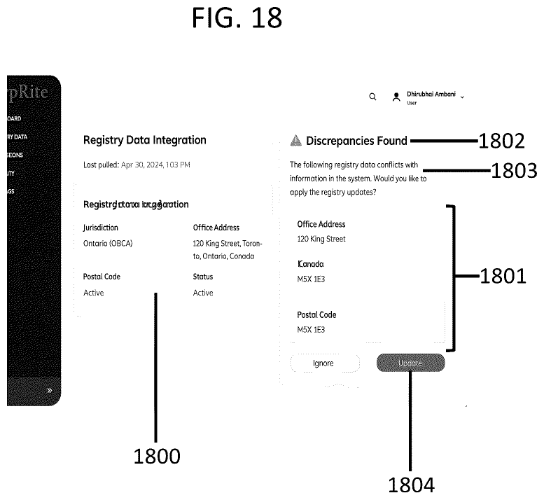

FIG. 18 illustrates an example of a user interface of the software application configured to, via a customized AI, extract registry data of an organization and generate discrepancies with information stored within the software application. The software application is configured to display, via the user interface, a comparison between real-time corporate data 1800 pulled from public registries and user-entered information 1801 provided to the software application and a notification of discrepancies found 1802. Using natural language cues and visual highlights, discrepancies are automatically detected by the software application, such as outdated officer appointments, incorrect addresses, or missing registration numbers. The software application is configured to generate and display suggested corrective actions 1803, such as updating internal records or filing new forms, and receive input designating an instruction to implement one or more suggestions 1804. This functionality maintains accurate and compliant corporate profiles, reducing manual errors and enhancing legal reliability through intelligent, real-time synchronization.

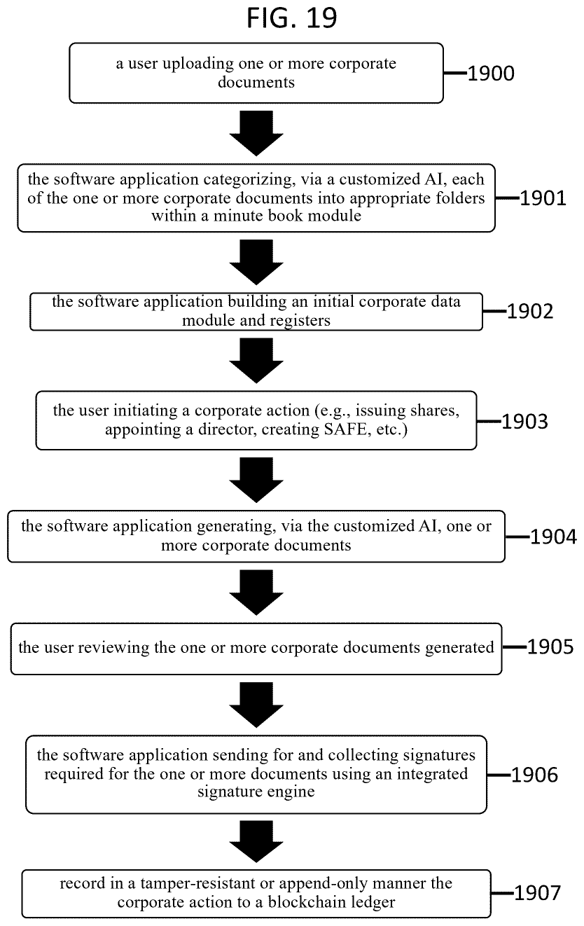

FIG. 19 illustrates an example of a workflow of the software application described herein, including: (1900) a user uploading one or more corporate documents; (1901) the software application categorizing, via a customized AI, each of the one or more corporate documents into appropriate folders within a minute book module; (1902) the software application building an initial corporate data module and registers; (1903) the user initiating a corporate action (e.g., issuing shares, appointing a director, creating SAFE, etc.); (1904) the software application generating, via the customized AI, one or more corporate documents; (1905) the user reviewing the one or more corporate documents generated; (1906) the software application sending for and collecting signatures required for the one or more documents using an integrated signature engine; and (1907) record in a tamper-resistant or append-only manner the corporate action to a blockchain ledger.

In some embodiments, transmissions and storage are encrypted.

Some embodiments of the present invention may be implemented as a system, a method, or a computer program product. Accordingly, aspects of the invention may take the form of hardware, software, or a combination of both. In particular, the invention may be implemented as a computer program embodied in a non-transitory, machine-readable medium storing instructions that, when executed by one or more processors, perform the operations described herein. The computer-readable media may include, without limitation, RAM, ROM, flash memory, magnetic storage, optical storage, or any other non-transitory medium capable of storing electronic instructions.

The software application or system may be deployed on a standalone device, in a distributed computing environment, within a cloud-based architecture, or across any suitable computing platform. Functionality may be implemented in discrete components, services, or modules that communicate through APIs, message queues, or other programmatic interfaces. Any specific references to programming languages, user interfaces, data structures, or database configurations are exemplary and not intended to be limiting.

The foregoing description of exemplary embodiments has been presented for purposes of illustration and explanation. It is not intended to be exhaustive or to limit the invention to the precise forms disclosed. Modifications and variations will be apparent to those skilled in the art in light of this disclosure. The embodiments were selected and described in order to best explain the principles and practical applications of the invention, and to enable others skilled in the art to utilize the invention in various embodiments and modifications appropriate to particular use cases. The scope of the invention is defined by the appended claims and their legal equivalents.

1. A tangible, non-transitory, machine-readable medium storing instructions that when executed by one or more processors cause the one or more processors to:
ingest and analyze corporate governance data from one or more sources comprising uploaded documents, internal records, and external data sources;
derive, from the analyzed corporate governance data, one or more of governance constraints, compliance conditions, and authorization requirements;
control execution of one or more corporate actions based on satisfaction of the one or more of the governance constraints, the compliance conditions, and the authorization requirements;
record execution of the one or more corporate actions in a tamper-resistant or append-only audit record; and
maintain a structured, entity-specific corporate state reflecting the executed one or more corporate actions;
wherein execution of the instructions is configurable per one or more of entity, jurisdiction, and user-defined governance policy.

2. The medium of claim 1, wherein the instructions executed by the one or more processors further cause the one or more processors to generate, using the machine learning engine, one or more legal documents or governance instruments comprising: incorporation papers, shareholder agreements, resolutions, option plans, and consents.

3. The medium of claim 1, wherein the instructions executed by the one or more processors further cause the one or more processors to:
store, using a minute book module, corporate documents comprising organizational documents, legal agreements, and board resolutions; and
link one or more of the stored documents to corresponding immutable audit events.

4. The medium of claim 1, wherein the instructions executed by the one or more processors further cause the one or more processors to:
identify, using the machine learning engine, one or more compliance gaps in corporate governance data;
invoke, using the smart contract engine, a remedial action upon identification of the one or more compliance gaps; and
execute, using the smart contract engine, the remedial action.

5. The medium of claim 1, wherein the instructions executed by the one or more processors further cause the one or more processors to:
detect, using the machine learning engine, discrepancies between internal records and public registry data; and
generate, file, or request registry updates to correct the discrepancies.

6. The medium of claim 1, wherein the instructions executed by the one or more processors further cause the one or more processors to assess, using the machine learning engine, legal and compliance posture, the assessment comprising:
assessing governance document completeness, registry mismatches, and filing history;
assigning a risk score based on the governance document completeness, the registry mismatches, and the filing history; and
suggesting corrective actions based on the assigned risk score or other findings from the assessment.

7. The medium of claim 1, wherein the predefined corporate actions comprise one or more of:
issuing equity as tokenized shares;
converting convertible instruments;
processing share transfers, redemptions, or conversions;
updating a cap table;
issuing dividends;
scheduling and executing shareholder votes or proxy solicitations;
distributing meeting notices or other stakeholder notifications;
enforcing vesting schedules;
performing share buybacks or treasury-share management;
handling equity splits or consolidations;
managing tokenized debt instruments;
triggering corporate events;
automating annual-report or other jurisdictional compliance filings;
minting or burning tokenized securities; and
generating and submitting regulatory filings or notices.

8. The medium of claim 1, wherein the governance rules comprise one or more of: board approved share caps; jurisdiction specific filing deadlines; super majority vote thresholds; and officer signature requirements.

9. The medium of claim 1, wherein the data-driven triggers comprise one or more of: a cap table dilution greater than or equal to a first threshold percentage; a financing round being closed; an option-pool utilization greater than or equal to a second threshold percentage;
and a compliance deadline occurring within a third threshold number of days.

10. The medium of claim 1, wherein the instructions executed by the one or more processors further cause the one or more processors to simulate, using the machine learning engine, changes to a cap table based on one or more hypothetical events defined by a user or derived from extracted corporate data, the simulation comprising one or more of: funding rounds; pro rata rights; option pool adjustments; and convertible note conversions.

11. The medium of claim 1, wherein the instructions executed by the one or more processors further cause the one or more processors to represent equity or convertible instruments as blockchain-based tokens governed by smart contract logic.

12. The medium of claim 1, wherein the instructions executed by the one or more processors further cause the one or more processors to manage access control and permissions via smart contract logic and blockchain-based identities.

13. The medium of claim 1, wherein the instructions executed by the one or more processors further cause the one or more processors to onboard multiple corporate entities, onboarding comprising:
uploading a digital minute book or governance documents;
extracting data from the digital minute book or governance documents using the machine learning engine;
retrieving supplemental corporate data from public registries; and
organizing the extracted data and the supplemental corporate data into structured corporate profiles.

14. The medium of claim 1, wherein the instructions executed by the one or more processors further cause the one or more processors to configure smart contract logic to vary execution based on user roles or digital signatures.

15. The medium of claim 1, wherein the instructions executed by the one or more processors further cause the one or more processors to:
dynamically generate, select, or modify one or more of governance and transactional document templates using a machine learning engine based on extracted corporate governance data, historical corporate actions, entity type, jurisdiction-specific requirements, and user role;
determine required approval thresholds and authorized signatories for execution of the one or more of the governance or the transactional documents; and
control execution of the corresponding one or more corporate actions such that execution is permitted only after receipt of required electronic signatures or approvals, wherein the executed one or more of the governance or the transactional documents and associated signature events are immutably linked to the corporate action record.

16. The medium of claim 1, wherein the instructions executed by the one or more processors further cause the one or more processors to:
retain, using a version control mechanism, historical records of corporate actions; and
record in a tamper-resistant or append-only manner, using the version control mechanism, new versions of corporate actions.

17. The medium of claim 1, wherein the instructions comprise a modular architecture that customizes workflows by entity, jurisdiction, or a user-defined governance policy.

18. The medium of claim 1, wherein the instructions executed by the one or more processors further cause the one or more processors to:
compute, using the machine-learning engine, a confidence score for each prospective corporate action; and
in response to the confidence score of a prospective corporate action falling below a predefined confidence threshold, route the prospective corporate action to a human for approval or manual execution, or in response to the confidence score of the prospective corporate action being above the predefined confidence threshold, automatically execute, using the smart contract engine, the prospective corporate action and record in a tamper-resistant or append-only manner the executed action to the blockchain ledger.

19. A system, comprising:
one or more processors; and
a non-transitory, machine-readable memory storing instructions that, when executed by the one or more processors, cause the one or more processors to:
ingest and analyze corporate governance data from one or more sources comprising uploaded documents, internal records, and external data sources;
derive one or more of governance constraints, compliance conditions, and authorization requirements from the analyzed corporate governance data;
control execution of one or more corporate actions based on satisfaction of the one or more of the governance constraints, the compliance conditions, and the authorization requirements;
record execution of the one or more corporate actions in a tamper-resistant or append-only audit record; and
maintain a structured, entity-specific corporate state reflecting the executed one or more corporate actions;
wherein the system is configurable per one or more of entity, jurisdiction, and user-defined governance policy.

20. A method, comprising:
ingesting and analyzing, by one or more processors, corporate governance data from one or more sources comprising uploaded documents, internal records, and external data sources;
deriving, by the one or more processors, one or more of governance constraints, compliance conditions, and authorization requirements from the analyzed corporate governance data;
controlling execution, by the one or more processors, of one or more of corporate actions based on satisfaction of the governance constraints, compliance conditions, and authorization requirements;
recording execution of the one or more corporate actions in a tamper-resistant or append-only audit record; and
maintaining a structured, entity-specific corporate state reflecting the executed one or more corporate actions;
wherein the method is configurable per one or more of entity, jurisdiction, and user-defined governance policy.
